(19) United States
(12) Patent Application Publication
(10) Pub. No.: US 2010/0097301 A1
(43) Pub. Date: Apr. 22, 2010

(54) LIGHT EMITTING APPARATUS AND IMAGE DISPLAY APPARATUS USING THE SAME

(75) Inventors: Toshiharu Sumiya, Atsugi-shi (JP); Hisanobu Azuma, Hadano-shi (JP); Jun Iba, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/580,760

(22) Filed: Oct. 16, 2009

(30) Foreign Application Priority Data
Oct. 22, 2008 (JP) 2008-272126

(51) Int. Cl. G09G 3/28; H01J 7/44

(52) U.S. Cl. 345/63; 315/32

(57) ABSTRACT

A light emitting apparatus includes a plurality of light emitting devices including luminous bodies, and a plurality of resistors made of the same material having negative resistance-temperature characteristics, the plurality of resistors being connected respectively in series to the plurality of light emitting devices. When the plurality of resisters are at the same temperature, one or ones among the plurality of resistors, which exhibit higher temperatures during driving, have larger resistance values than other among the plurality of resistors, which exhibit lower temperatures during the driving.

### BACKGROUND OF THE INVENTION

1. Field of the Invention

The present invention relates to a light emitting apparatus capable of reducing nonuniformity (unevenness) in a displayed image, which is caused by temperature distribution.

2. Description of the Related Art

Heating of light emitting apparatus itself and heating of a driving apparatus, etc., which are generated when the light emitting apparatus is driven, may generate temperature distribution in the light emitting apparatus. Recently, a flat panel display used as a light emitting apparatus has been required to have a larger size, and temperature distribution generated in the light emitting apparatus has become more significant with an increase in the panel size.

The temperature distribution thus generated may be observed as nonuniformity in a displayed image depending on temperature characteristics of various members constituting the light emitting apparatus. Accordingly, it is required to compensate for temperature changes and temperature distribution.

Japanese Patent Laid-Open No. 2001-282179 discloses a cold cathode display apparatus including a resistance layer made of an amorphous silicon material, which is disposed between a cold cathode and a cathode electrode. The amorphous silicon material has a negative resistance-temperature characteristic. Thus, a resistance value of the resistance layer reduces as the environmental temperature rises, whereby luminous brightness varies. By providing a temperature sensor for detecting the temperature of the resistance layer, therefore, an amount of electrons emitted from the cold cathode can be controlled in accordance with an output of the temperature sensor.

However, the technique of controlling a signal in accordance with the output of the temperature sensor, as proposed in Japanese Patent Laid-Open No. 2001-282179, has the problems that the display apparatus is complicated in itself because of the provision of the temperature sensor, an additional circuit is required to perform sophisticated signal control, and hence the cost is increased.

### SUMMARY OF THE INVENTION

An exemplary embodiment of the present invention provides a light emitting apparatus which can compensate for temperature changes and temperature distribution without making the apparatus structure more complicated.

According to one exemplary embodiment of the present invention, a light emitting apparatus includes a plurality of light emitting devices including luminous bodies, and a plurality of resistors having a negative resistance-temperature characteristic, the plurality of resistors being connected respectively in series to the plurality of light emitting devices, the plurality of resistors exhibiting different temperatures from each other during driving, wherein the plurality of resistors are made of the same material, and when the plurality of resisters are at the same temperature, one or ones among the plurality of resistors, which exhibit higher temperatures during the driving, have larger resistance value at the same temperature than other one or ones among the plurality of resistors, which exhibit lower temperatures during the driving.

With the exemplary embodiments of the present invention, variations among the resistance values of the resistors due to temperature distribution caused during driving and nonuniformity in brightness among the light emitting devices can be reduced without making the light emitting apparatus more complicated.

Further features of the present invention will become apparent from the following description of exemplary embodiments with reference to the attached drawings.

### BRIEF DESCRIPTION OF THE DRAWINGS

FIGS. 1A to 1C are schematic views illustrating a light emitting apparatus according to an exemplary embodiment of the present invention.

FIG. 2 is an illustration to explain a reference temperature distribution in the exemplary embodiment of the present invention.

FIG. 3 is a graph illustrating a first exemplary embodiment of the present invention.

FIG. 4 is a graph illustrating a second exemplary embodiment of the present invention.

FIG. 5 is a sectional view illustrating the basic structure of a light emitting apparatus using electron emitting devices.

FIG. 6 is a plan view illustrating the structure of a rear plate.

FIG. 7 is a plan view illustrating the structure of a face plate.

FIG. 8 is an illustration to explain the electron emitting devices and wirings.

FIG. 9 illustrates a manner of adjusting a resistance value depending on the length of a resistor.

FIG. 10 illustrates a manner of adjusting a resistance value depending on the width of a resistor.

FIGS. 11A and 11B illustrate a manner of adjusting a resistance value depending on the thickness of a resistor.

FIGS. 12A, 12B and 12C illustrate a manner of adjusting a resistance value depending on the size of a contact area between a resistor and an electrode.

FIGS. 13A and 13B are plots illustrating respectively a reference temperature distribution and a resistance distribution at the same temperature in Example 1.

FIGS. 14A, 14B and 14C are plots illustrating respectively a reference temperature distribution, a resistance distribution at the same temperature, and a resistance distribution during driving in Example 2.

FIGS. 15A and 15B are plots illustrating respectively a reference temperature distribution and a resistance distribution at the same temperature in Example 3.

FIGS. 16A and 16B are respectively a plan view and a sectional view of the electron emitting device in Example 4.

FIGS. 17A to 17E illustrate successive steps of manufacturing the electron emitting device and the wirings in Example 4.

FIGS. 18A to 18E illustrate successive steps of manufacturing the electron emitting device in Example 4.

FIGS. 19A, 19B and 19C illustrate a manner of adjusting a resistance value in Example 4.

FIG. 20 is a table representing evaluation results of Examples 1 to 4 and Comparative Examples 1 to 3.

FIG. 21 is a graph illustrating a resistance distribution when a temperature distribution is generated without providing any resistance distribution at the same temperature.

### DESCRIPTION OF THE EMBODIMENTS

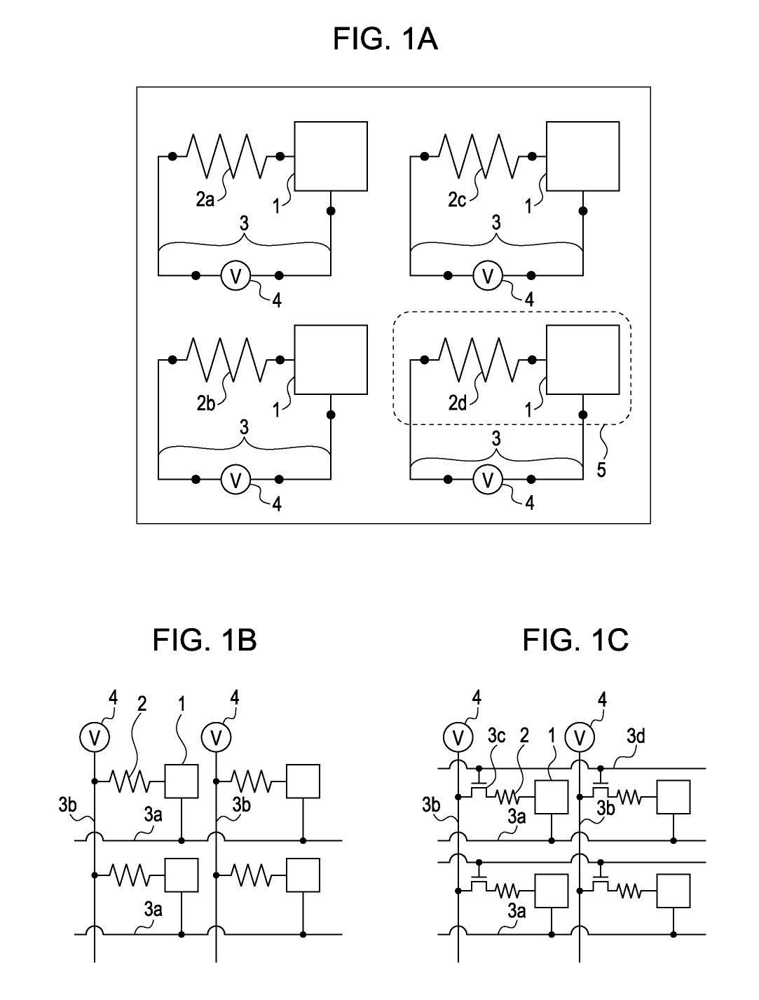

An exemplary embodiment of the present invention will be described below. As illustrated in FIG. 1A, a light emitting apparatus according to the exemplary embodiment of the present invention includes at least a plurality of light emitting devices 1 each having a luminous body, and a plurality of resistors 2 (specifically, resistors 2a to 2d) each of which is connected in series to the corresponding light emitting device 1 and has a negative resistance-temperature characteristic. The resistors 2a to 2d are made of the same material, but at least one of the resistors 2a to 2d has a resistance value differing from those of the other resistors at the same temperature. Resistance values of all the resistors 2a to 2d may differ from one another. A predetermined voltage is applied to each light emitting device 1 and each resistor 2 through a wiring 3 and a driving unit 4. A potential difference corresponding to a voltage dropped by the presence of the resistor 2 generates in the light emitting device 1, whereupon the light emitting device 1 emits light. While the light emitting apparatus 10 includes four light emitting devices 1 and four resistors 2 in FIG. 1A, the number of such a component is just required to be two or more. Practically, the light emitting devices 1 and the resistors 2 may be arrayed in number more than 100 in one case or more than 1,000,000 in another case. Also, while one resistor 2 is connected to one light emitting device 1 in the illustrated exemplary embodiment, one resistor may be connected in series to a plurality of light emitting devices 1. Further, it is just required that the light emitting device 1 and the resistor 2 are electrically connected in series. In other words, an additional wiring or electrode may be disposed between the light emitting device 1 and the resistor 2. The positional relationship among those components is not limited to particular one unless otherwise specified.

The light emitting device 1 is just required to emit light upon application of a voltage or a current. The light emitting device 1 is, e.g., an incandescent lamp. A preferred example of the light emitting device 1 is a photoluminescence device including a phosphor, such as a plasma cell or a cold cathode/hot cathode fluorescent tube. Another preferred example of the light emitting device 1 is an electroluminescence device, such as an organic EL device, an inorganic EL device, or a light emitting diode. A more preferred light emitting device is a cathode luminescence device in which a phosphor is excited so as to emit light upon irradiation of an electron beam emitted from an electron emitting device. Any of the above-described self-luminous devices can be suitably employed as the light emitting device in the exemplary embodiment of the present invention.

When the light emitting device 1 is one of the above-described luminescence devices, it includes not only a luminous body (e.g., a phosphor (fluorescent body), a phosphorescent body, or a semiconductor junction) that emits light by itself, but also an excitation unit for exciting the luminous body so as to emit light. The excitation unit includes, for example, gas conversable to a plasma state, a discharge device for generating plasma, an electron/hole injection layer, and an electron emitting device for emitting electrons. In the case of the luminescence device, the luminous body is excited so as to emit light upon application of a voltage to the excitation unit for the light emitting device 1. When one light emitting device 1 includes a plurality of excitation units, a plurality of resistors 2 may be connected in series to each of the excitation units.

When the light emitting apparatus is constituted as a color light emitting apparatus, other light emitting devices emitting different colors from that of the light emitted from the light emitting device 1 are additionally provided. For example, when the light emitting device 1 emits red light, other light emitting devices emitting green and blue lights are additionally provided. In that case, one light emitting device 1 typically constitutes one sub-pixel (sub-picture element). A plurality of sub-pixels providing respectively different colors cooperatively constitute one pixel (picture element). As a matter of course, the exemplary embodiment of the present invention can also be applied to each of the light emitting devices emitting lights in colors differing from that of the light emitted from the light emitting device 1 by connecting a resistor in series as with the light emitting device 1. When a plurality of fluorescent tubes or light emitting diodes are used for backlight of a liquid crystal shutter device, the plurality of fluorescent tubes or light emitting diodes are each regarded as the light emitting device 1.

A configuration including the light emitting device 1 and the resistor 2 arranged adjacent to each other is here called a “light emitting unit 5”. A structure obtained by providing the light emitting device 1 and the resistor 2 in each area corresponding to one sub-pixel can be regarded as the light emitting unit 5 in which the light emitting device 1 and the resistor 2 are arranged adjacent to each other. In other words, a plurality of light emitting units 5 constitute the light emitting apparatus. In the case of a color light emitting apparatus, the light emitting units providing lights in different colors constitute one pixel, and a plurality of pixels constitute the light emitting apparatus.

The resistor 2 will be described in more detail below.

The term “negative resistance-temperature characteristic” implies a characteristic that a resistance value reduces as temperature rises. Such a resistance-temperature characteristic can be typically approximated by the following exponential function:

R=R₀exp{(Eₐ/k_{b})×(1/T−1/T₀)} (1)

In the formula (1), R is a resistance value (Ω) at a temperature T(K), R₀ is a resistance value (Ω) at a temperature T₀(K), Eₐ is activation energy (eV) of a material, and k_{b} is the Boltzmann's constant (8.617×10⁻⁵ (eV/K)). The activation energy Eₐ represents the magnitude of the resistance-temperature characteristic. The smaller a value of activation energy, the smaller is a change of the resistance value depending on temperature. Generally, the activation energy has a value of about 0.05 to 1 eV. Incidentally, Eₐ/k_{b} is also called the “B constant”.

Further, the resistance value R₀ is represented by R₀=ρ₀tw/1 using a volume resistivity p₀ (Ωm), a sectional thickness t (m), a sectional width w (m), and a length l (m) in the direction in which a current flows, at the temperature T₀ of the resistance material.

Generally, many materials having large volume resistivities are semiconductors and exhibit negative resistance-temperature characteristics in many cases. In particular, when trying to obtain a larger resistance value by reducing t and w, the volume resistivity ρ₀ is increased. Also, the material having a larger volume resistivity generally has a higher level of activation energy and causes a larger reduction in volume resistivity depending on temperature changes.

A manner of applying a voltage to the light emitting device 1 and the resistor 2 is not limited to particular one. As illustrated in FIG. 1A, the voltage may be applied to one light emitting unit 5 by using one independent set of the driving unit 4 and the wirings 3. When the resistors 2 or the light emitting units 5 are arrayed in a two-dimensional (matrix) pattern, the wirings 3 are desirably in the form of matrix wirings as illustrated in FIG. 1B or 1C. The matrix wirings can be practiced, as illustrated in FIG. 1B, by a method (called “simple matrix wiring”) in which the light emitting units 5 are driven by using a plurality of first wirings 3a, i.e., a plurality of row-direction wirings, which are in common to the light emitting devices 1 arranged in the row direction, and second wirings 3b, i.e., a plurality of column-direction wirings, which are in common to the light emitting devices 1 arranged in the column direction. Alternatively, the matrix wirings can also be practiced, as illustrated in FIG. 1C, by a method (called “active matrix wiring”) in which a transistor 3c, e.g., a TFT, is disposed per light emitting device 1 and the light emitting devices 1 are driven by turning on/off the transistors 3c through a plurality of third wirings 3d, i.e., gate wirings. At least one of the wirings 3a, 3b and 3d may be constituted as a common wiring for providing an equal potential to two or more of the wirings. Further, part of the wiring 3 may be formed by a member common to part of the light emitting device 1. While the resistor 2 is disposed between the transistor 3c and the light emitting device 1 in FIG. 1C, the resistor 2 may be disposed between the second wiring 3b and the transistor 3c or between the light emitting device 1 and the first wiring 3a.

An image display apparatus is obtained by providing a scanning circuit to select the light emitting device 1 to be driven, and by energizing the driving unit 4, which is connected to the wirings 3, for each of the light emitting devices 1. A modulation circuit for modulating the voltage applied to the driving unit 4 may be provided for the purpose of gradient light emission. Thus, the driving unit 4 may include the scanning circuit and the modulation circuit.

In the exemplary embodiment of the present invention, the plurality of the resistors 2 each having a negative resistance-temperature characteristic may have the other function than that of reducing an extent of the resistance distribution. Examples of the effect of the resistor 2 will be described below.

The resistor 2 has the function of dropping a voltage and limiting a current flowing through the light emitting device 1 so as to prevent the problem that an excessive current flows through the light emitting device 1 and damages the light emitting device 1. In the case of the active matrix wiring illustrated in FIG. 1C, the transistor 3c can also have the function of limiting the current. In the case of the simple matrix wiring illustrated in FIG. 1B, only the resistor 2 is required to have that function. Accordingly, the resistor 2 is required to have a higher resistance value in the simple matrix wiring. For that reason, the exemplary embodiment of the present invention is more effectively applied to the light emitting apparatus using the simple matrix wiring.

Further, the individual light emitting devices 1 have a variation in their characteristics for the reasons attributable to the manufacturing process, etc. Therefore, the resistors 2 also have the function of reducing the variation in characteristics of the individual light emitting devices 1 when the resistors 2 are connected in series to the light emitting devices 1. The resistors 2 having larger resistance values are more effective in reducing the characteristic variation. However, the resistor 2 having a larger resistance value simultaneously provides a larger voltage drop by itself and requires a larger voltage to drive the light emitting device 1. Accordingly, the resistance value of the resistor 2 is determined in consideration of a balance between a degree of the characteristic variation and an allowable value of the voltage drop. Another factor determining the resistance value of the resistor 2 is the relationship between the voltage applied through the wirings 3 and the brightness of the light emitting device 1. When the variation is relatively large due to the problem with the manufacturing process and the problem specific to the device, the resistor 2 is required to have a larger resistance value.

In the light emitting apparatus, temperature distribution generates due to heating of the light emitting devices 1, the resistors 2, and the wirings 3, and other heat sources, such as electric circuits including the driving unit 4. The temperature distribution is determined depending on not only structural conditions, such as the structure of the light emitting apparatus, arrangement of the electric circuits including the driving unit 4, fans for cooling the electric circuits, etc., and the shape of a chassis to accommodate the light emitting apparatus, but also operating conditions, such as an installation environment, an installation method, and a display pattern.

However, main factors generating the temperature distribution are the structural conditions, and the temperature distribution exhibits substantially the same tendency without depending on the operating conditions. For example, when the light emitting apparatus has a rectangular shape, a temperature rise is relatively small in a peripheral portion where heat is more apt to radiate, and it is relatively large in a central portion where heat is less apt to radiate. Further, when the heat sources, such as the electric circuits, and heat exhausting elements, such as the fans, are localized, the temperature distribution generates depending on arrangement of the heat sources and the heat exhausting elements. When the heat sources are positioned in a central portion of a rear surface (i.e., a surface opposed to a display surface) of the light emitting apparatus, a temperature rise is relatively large in the central portion due to the heating of the heat sources. It is hence possible to estimate the tendency of temperature distribution that generates when the light emitting apparatus is driven.

In the exemplary embodiment of the present invention, therefore, the temperature distribution in the light emitting apparatus is previously determined which is estimated to generate when the light emitting apparatus is driven. The estimated temperature distribution is one set based on the temperature distribution which is obtained when the light emitting apparatus is driven under predetermined conditions, and which is called a “reference temperature distribution”.

The predetermined conditions for setting the reference temperature distribution are such that the light emitting apparatus is driven at a predetermined environmental temperature and a predetermined gradation (or brightness) for a predetermined time.

The predetermined environmental temperature is within the range of the operating environmental temperature defined for the light emitting apparatus. In practice, the predetermined environmental temperature is desirably room temperature (e.g., 300K).

The predetermined time can be optionally determined. For example, the predetermined time may be a time during which users of the light emitting apparatus continuously operate the apparatus in average. The reference temperature distribution may be determined based on average values of temperatures at various points during the average operating time. Generally, the temperature distribution caused in the light emitting apparatus is saturated at an equilibrium state between heat generating factors and heat radiating factors. Therefore, the predetermined time is desirably set to a time necessary for a temperature change to saturate or substantially saturate. Although the time necessary for a temperature change to saturate depends on the size of the light emitting apparatus and a heat diffusion characteristic thereof, it is usually about 5 to 10 minutes, or about 30 to 180 minutes in the case of a long saturation time, counting from the start of the driving. The reference temperature distribution can be determined with higher accuracy by averaging temperature changes for a certain time after the saturated state has been reached.

The display pattern during the driving should be set to a pattern in which all the light emitting devices are turned on at a predetermined gradation described below. When there are light emitting devices emitting lights in plural colors, those light emitting devices should be all turned on. The predetermined gradation is desirably set to a gradation at which the difference between a maximum (highest) temperature and a minimum (lowest) temperature in the temperature distribution is maximized. The reference temperature distribution may be set through the steps of measuring temperature distributions at several gradations changed one by one, determining the gradation at which an average temperature distribution is obtained, and selecting the average temperature distribution as the reference temperature distribution. More specifically, the gradation may be set to be not more than 100% and not less than 20%, desirably not more than 50% and not less than 20%. When the display apparatus is a television, a gradation of 20% is desirable, but a gradation of 50% is sufficiently satisfactory from the practical point of view.

In view of the above-described points, the reference temperature distribution can be typically set based on the temperature distribution that is obtained when the light emitting apparatus is driven at the environmental temperature of 300K and the brightness of 50% for 60 minutes.

The temperature distribution in the light emitting apparatus when it is driven under the thus-determined predetermined conditions can be measured by attaching a plurality of temperature sensors, e.g., thermocouples, to the light emitting apparatus. As an alternative, that temperature distribution may be observed by the infrared thermography. When the temperature sensors are used, it is not necessary to measure temperatures at all points in the light emitting apparatus. In other words, the number of measurement points may be set to such a value as allowing the temperature distribution over an entire light emitting area to be sufficiently estimated. The temperature measurement is desirably performed in an environmental test room.

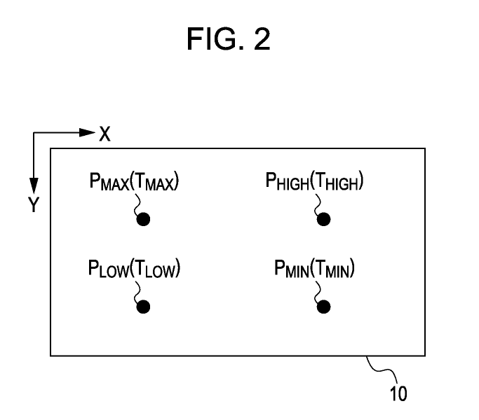

FIG. 2 illustrates a simple example of the temperature distribution determined as described above. It is here assumed that, when the light emitting apparatus is driven under the predetermined conditions, different temperature changes occur at four points P_{MIN}, P_{LOW}, P_{HIGH}, and P_{MAX} where the resistors 2 of the light emitting apparatus 10, illustrated in FIG. 2, are positioned. Respective temperatures of the resistors 2 at those four points P_{MIN}, P_{LOW}, P_{HIGH}, and P_{MAX} are T_{MIN}, T_{LOW}, T_{HIGH}, and T_{MAX} at the measurement time. Further, the relationship of T_{MIN}<T_{LOW}<T_{HIGH}<T_{MAX} holds.

In fact, because of a difficulty in continuously defining the temperature distribution, the reference temperature distribution is defined by measuring the temperature in each of a plurality of divided regions and regarding the resistors included in each of the divided regions to be at the same temperature. Stated another way, the reference temperature distribution may be set as a temperature distribution representing the temperatures of the resistors, which are grouped into a plurality of different regions. A level of accuracy in compensating for the temperature distribution is increased by increasing the number of divided regions such that a temperature range in each region is narrowed. For the sake of simpler explanation, the above-described temperature distribution is assumed here to be the reference temperature distribution.

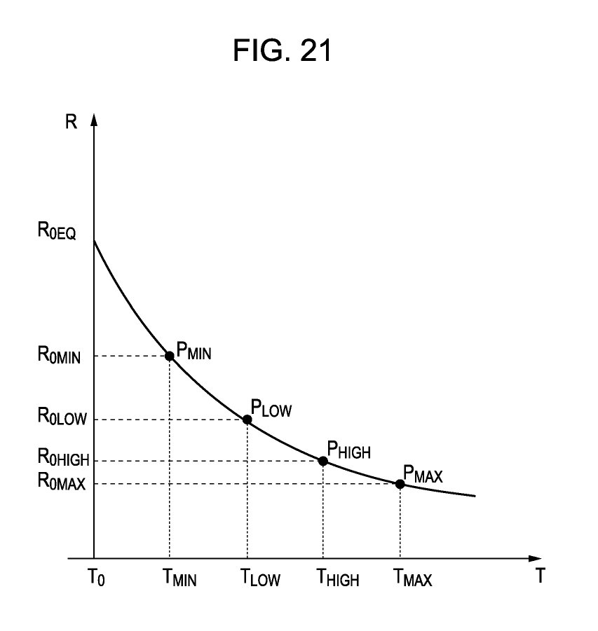

As a reference mode for the exemplary embodiment of the present invention, the following description is made about the case that, when the temperatures of the resistors 2 in the light emitting apparatus 10 are the same, i.e., T₀ (the temperature of the individual resistors at that time is called here the “same (equal) temperature”), the resistances of the resistors 2 have the same value R_{0EQ}. The state of the same temperature is obtained, for example, when the light emitting apparatus 10 is statically installed in a space at an environmental temperature of T₀ without driving the light emitting apparatus and the temperatures of the resistors 2 are all T₀. When the light emitting apparatus is driven and the temperature distribution represented by T_{MIN}, T_{LOW}, T_{HIGH}, and T_{MAX} generates as described above, changes in resistance values of the resistors are as per illustrated in FIG. 21, which is a graph representing the formula (1). In FIG. 21, the horizontal axis indicates the temperature of the resistor, and the vertical axis indicates the resistance value of the resistor. As seen from FIG. 21, when the temperature distribution occurs, the resistance values of the resistors at the points P_{MIN}, P_{LOW}, P_{HIGH}, and P_{MAX} are provided by R_{0MIN}, R_{0LOW}, R_{0HIGH}, and R_{0MAX}, respectively. Those resistance values have the magnitude relationship of R_{0MIN}>R_{0LOW}>R_{0HIGH}>R_{0MAX}, thus causing a variation in the resistance values. Such a variation in the resistance values leads to a variation in the voltages applied to the light emitting devices 1, and it is observed as nonuniformity of brightness depending on the temperature distribution.

In the exemplary embodiment of the present invention, the expression “resistance value is equal” implies that a percentage of the difference between two values with respect to an arithmetic mean of those two values (hereinafter referred to as a “middle value”) is less than 1%. Also, the expression “variation (distribution or nonuniformity) in the resistance value is reduced” or “variation (distribution or nonuniformity) is small” implies that a percentage of the difference between two values with respect to a middle value of those two values is desirably less than 10%. When evaluation is made on three or more values, a percentage is calculated as percents of the difference between a maximum value and a minimum value with respect to a middle value of the maximum value and the minimum value or with respect to an arithmetic mean of those three or more values (hereinafter referred to as a “mean value”). Assuming values of two resistances to be R_{A} and R_{B} (R_{A}>R_{B}), the above-described condition can be expressed by 200×(R_{A}−R_{B})/(R_{A}+R_{B})<1% or 10%. By rewriting that formula in terms of R_{A}/R_{B}, R_{A} and R_{B} can be regarded as being equal to each other when the resistance value R_{A} is less than 101% of the resistance value R_{B}. Also, a variation of R_{A} and R_{B} can be regarded as being small when the resistance value R_{A} is less than 111% of the resistance value R_{B}.

Further, in the exemplary embodiment of the present invention, the temperature difference that can be regarded as indicating the “same temperature” is, strictly speaking, a temperature difference resulting when the “equal resistance” is obtained based on the above-mentioned formula (1), and such a temperature difference differs depending on not only the temperatures (T₀ and T) serving as references to define the temperature difference, but also the activation energy Eₐ.

As seen from quantitative calculations based on the above-mentioned formula (1), when the resistance variation is relatively small at a low value (0.05 eV) of the activation energy Eₐ and at a high temperature (about 330K) of the resistor, the resistance value varies less than 1% if a temperature change is less than 2K.

Further, even when the resistance variation is relatively large at a high value (1 eV) of the activation energy Eₐ and at a low temperature (about 270K) of the resistor, the resistance variation remains less than 1% if a temperature change is less than 0.06K. Thus, when the temperature change is less than 0.06K, the resistance change can be considered as causing substantially no problems. Accordingly, it is most desirable that two temperatures are regarded to be at the “same temperature” when the temperature change is less than 0.06K.

Moreover, as seen from calculations based on the above-mentioned formula (1), even when the resistance variation is relatively small at a low value (0.05 eV) of the activation energy Eₐ and at a high temperature (about 330K) of the resistor, the resistance value varies 10% or more if the temperature change is 20K or more. Accordingly, the exemplary embodiment of the present invention can be most desirably applied to the case where there occurs a temperature difference of 20K or more during the driving. Stated another way in a reversed view, the resistance variation of 10% or more does not generate unless there occurs a temperature distribution varying 20K or more. On the contrary, at the activation energy of 0.1 eV or more, the resistance variation of 10% or more generates if there occurs a temperature change of 10K or more at 270 to 330K. In practice, therefore, the exemplary embodiment of the present invention is desirably applied to the case where a material having the activation energy of 0.1 eV or more is used.

On the other hand, when the resistance variation is relatively large at a high value (1.0 eV) of the activation energy Eₐ and at a low temperature (about 270K) of the resistor, the resistance value varies 10% or more if the temperature change is 0.6K or more. It is not desirable to use, as the resistor, a material having a resistance value that is apt to vary depending on such a slight temperature change. Meanwhile, when the activation energy is 0.6 eV or less, the resistance variation of 10% or more does not occur at about 270K for the temperature change of less than 1K. Further, when the activation energy is 0.1 eV or more, the resistance variation of 1% or more occurs for the temperature change of 1K or more.

From the above-described point of view, it is typically considered that, when a material having the activation energy of not less than 0.1 eV and not more than 0.6 eV is used as the resistor 2, the temperature difference of less than 1K can be regarded as indicating the “same temperature”. Hence, the above-described temperature range as a unit for division of the reference temperature distribution is desirably set to 1K.

A method of reducing nonuniformity in a displayed image according to the exemplary embodiment of the present invention will be described below. A first exemplary embodiment is to reduce a variation in the resistance values of the resistors 2 during the driving. A second exemplary embodiment is to reduce a variation in brightness in consideration of respective temperatures of the light emitting devices 1 connected to the resistors 2.

### First Exemplary Embodiment

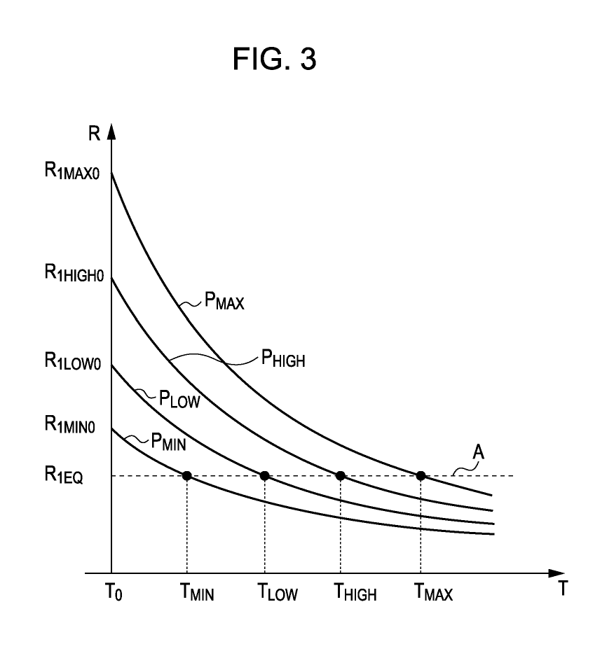

A method of setting a resistance distribution among the resistors 2 in the first exemplary embodiment of the present invention is described with reference to FIGS. 2 and 3. In FIG. 3, the horizontal axis indicates the temperature of each resistor, and the vertical axis indicates the resistance value of each resistor. Four solid lines represent resistance-temperature characteristics of the resistors 2 at P_{MIN}, P_{LOW}, P_{HIGH}, and P_{MAX}, respectively.

In the light emitting apparatus 10, resistance values of the resistors 2 positioned at P_{LOW} and P_{HIGH} at the temperature (same temperature) T₀, i.e., at the time when the temperatures of the resistors are the same, are assumed to be respectively R_{1LOW0} and R_{1HIGH0}. Resistance values R_{1LOW} and R_{1HIGH} of the resistors 2 positioned at P_{LOW} and P_{HIGH} in a state providing the reference temperature distribution are expressed, based on the above-mentioned formula (1), by the following formulae (2) and (3), respectively:

R_{1LOW}=R_{1LOW0}exp{(Eₐ/k_{b})×(1/T_{LOW}−1/T₀)} (2)

R_{1HIGH}=R_{1HIGH0}exp{(Eₐ/k_{b})×(1/T_{HIGH}−1/T₀)} (3)

In this first exemplary embodiment, the resistance values in the state providing the reference temperature distribution are made equal to each other. In other words, R_{1LOW}=R_{1HIGH}=R_{1EQ} are to be held. R_{1EQ} is a resistance value necessary for properly driving the light emitting device 1 and is set as appropriate. From the formulae (2) and (3), it is understood that R_{1LOW0} and R_{1HIGH0} are required to be given by the following formulae (2′) and (3′), respectively:

R_{1LOW0}=R_{1EQ}exp{(Eₐ/k_{b})×(1/T₀−1/T_{LOW})} (2′)

R_{1HIGH0}=R_{1EQ}exp{(Eₐ/k_{b})×(1/T₀−1/T_{HIGH})} (3′)

Further, from the formulae (2) and (3), the relationship between R_{1LOW0} and R_{1HIGH0} is expressed by the following formula (4):

R_{1HIGH0}=R_{LOW0}exp{(Eₐ/k_{b})×(1/T_{LOW}−1/T_{HIGH})} (4)

Accordingly, if R_{1HIGH0} and P_{1LOW0} are in the relationship expressed by the formula (4), the resistance values of the resistors in the state providing the reference temperature distribution can be made equal to each other. When the formula (4) is rewritten into;

R_{1HIGH0}/R_{1LOW0}=exp{(Eₐ/k_{b})×(1/T_{LOW}−1/T_{HIGH})} (4′)

the right side of the formula (4′) takes a value larger than 1, thus resulting in R_{1HIGH0}/R_{1LOW0}>1. In other words, the resistance variation can be reduced by setting the resistance value R_{1HIGH0} of the resistor at T₀, which is positioned at P_{HIGH}, to be larger than the resistance value R_{1LOW0} of the resistor at the same temperature T₀, which is positioned at P_{LOW}. For all the resistors, more desirably, the resistor having a higher temperature in the reference temperature distribution is set to have a larger resistance value at the same temperature.

A range of the resistance value R₀ at an arbitrary point P_{XY} within the light emitting area and at the temperature T₀ can be determined by measuring at least the point P_{MAX} where the temperature is maximized, and the point P_{MIN} where the temperature is minimized.

Assuming that resistance values of the resistors 2 positioned at the points P_{MAX} and P_{MIN}, which provide a maximum temperature T_{MAX} and a minimum temperature T_{MIN} in the reference temperature distribution, are respectively R_{1MAX0} and R_{1MIN0} at the temperature T₀, resistance values R_{1MAX} and R_{1MIN} of the resistors 2 positioned at the points P_{MAX} and P_{MIN} in the state providing the reference temperature distribution are expressed, based on the above-mentioned formula (1), by the following formulae (5) and (6), respectively:

R_{1MAX}=R_{1MAX0}exp{(Eₐ/k_{b})×(1/T_{MAX}−1/T₀)} (5)

R_{1MIN}=R_{1MIN0}exp{(Eₐ/k_{b})×(1/T_{MIN}−1/T₀)} (6)

Because R_{1MAX}=R_{1MIN}=R_{1EQ} are required to be satisfied, it is understood from the formulae (5) and (6) that R_{1MAX0} and R_{1MIN0} are required to be given by the following formulae (5′) and (6′), respectively:

R_{1MAX0}=R_{1EQ}exp{(Eₐ/k_{b})×(1/T₀−1/T_{MAX})} (5′)

R_{1MIN0}=R_{1EQ}exp{(Eₐ/k_{b})×(1/T₀−1/T_{MIN})} (6′)

Further, the relationship between R_{1MAX0} and R_{1MIN0} is expressed by the following formulae (4):

R_{1MAX0}=R_{1MIN0}exp{(Eₐ/k_{b})×(1/T_{MIN}−1/T_{MAX})} (7)

Accordingly, a resistance value R_{1XY0} at an arbitrary point P_{XY}, which takes a temperature T_{XY}, at the same temperature T₀ is required to be set within the range expressed by the following formula (8):

R_{1MIN0}≦R_{1XY0}≦R_{1MIN0}exp{(Eₐ/k_{b})×(1/T_{MIN}−1/T_{MAX}) } (8)

On that occasion, if R_{1XY0} at the point taking the temperature T_{XY} near T_{MIN} is set to a value near R_{1MAX0}, such setting may often increase the variation contrary to the intention. To avoid the unintended setting, R_{1XY0} is desirably required to satisfy not only the above formula (8), but also the following formula (9):

R_{1XY0}≦R_{1EQ}exp{(Eₐ/k_{b})×(1/T₀−1/T_{XY})} (9)

Such requirement corresponds to the fact that, when T_{XY} is T_{LOW}, R_{1XY0} is set to fall within a range larger than R_{1MIN0}and not larger than R_{1LOW0} expressed by the formula (2′). Also, such requirement corresponds to the fact that, when T_{XY} is T_{HIGH}, R_{1XY0} is set to fall within a range between R_{1MIN0} and R_{1HIGH0} expressed by the formula (3′). By setting R_{1XY0} to fall within the above-mentioned range, the resistance value of the resistor in the state providing the reference temperature distribution can be made closer to R_{1EQ} with no necessity of always satisfying R_{1HIGH0}>R_{1LOW0}. The case where the sign of inequality holds in the formula (9) corresponds to the fact that, in FIG. 3, the resistance value of each resistor during the driving takes a value falling within a region surrounded by a line A and a line P_{MIN}. The case where the sign of equality holds in the formula (9) is more desirable because the resistance values of all the resistors 2 are equal to each other in the state providing the reference temperature distribution. The line A in FIG. 3 represents the case where the resistance values of all the resistors 2 become the equal (same) value R_{1EQ} during the driving.

While the above description has been made about the method of giving a distribution to the resistance values at the same temperature depending on the reference temperature distribution, the following description is made about a method that can be more universally carried out in practice. When the resistors 2 are arrayed in the two-dimensional matrix pattern as described above, a temperature rise is relatively small in the peripheral portion of the light emitting apparatus 10 where heat is more apt to radiate, and it is relatively large in a central portion where heat is less apt to radiate. Accordingly, from the viewpoint of the concept of the “greatest common divisor”, i.e., from the viewpoint of dividing the reference temperature distribution into main basic regions, the reference temperature distribution can be imaginarily simply divided such that the temperature is high in a central portion and gradually lowers toward a peripheral portion. The expression “central portion” implies a center in a part of the light emitting apparatus 10, which has a maximum width, including the surroundings of the center (i.e., a central area). The expression “peripheral portion” implies an area positioned nearer to an edge (end) within 10% of the distance from the center to the edge. For example, when the light emitting apparatus 10 has a rectangular shape, the center is a middle point (crossed point) of diagonals of the rectangle. In that case, it is desirable that the reference temperature in the central portion provides the maximum (highest) temperature in the actually measured temperature distribution, and that the reference temperature in the peripheral portion farthest away from the central portion provides the minimum (lowest) temperature therein.

Further, the resistance values of the resistors at the same temperature are set so as to gradually reduce in the direction toward the peripheral portion from the central portion, namely, with an increase of the distance from the central portion. The direction toward the peripheral portion from the central portion (i.e., the direction away from the central portion) implies all directions radially extending from the central portion.

By setting the resistance values of the resistors as described above, nonuniformity in the displayed image attributable to the temperature distribution can be satisfactorily reduced even when the actually generated temperature distribution slightly deviates from the imaginarily set one.

As described above, the first exemplary embodiment can suppress a variation in the resistance values of the resistor having a relatively high temperature and the resistor having a relatively low temperature, which occurs during the driving of the light emitting apparatus 10. Therefore, nonuniformity in the brightness can be reduced without making the light emitting apparatus more complicated. In particular, a more satisfactory result is obtained when the light emitting apparatus is driven under the predetermined conditions used for setting the reference temperature distribution. In other words, a more satisfactory result is typically obtained when the light emitting apparatus is driven at the environmental temperature of 300K for 60 minutes with brightness of 50% for all the light emitting devices.

### Second Exemplary Embodiment

The first exemplary embodiment has been described as reducing a variation in the resistance values of the resistors 2 in the state providing the reference temperature distribution. A second exemplary embodiment will be described below in connection with the case of reducing nonuniformity in brightness among the plurality of light emitting devices 1 in the state providing the reference temperature distribution.

As described above, nonuniformity in brightness among the plurality of light emitting devices 1 can be reduced in the first exemplary embodiment. In some light emitting device, however, the light emission efficiency of the luminous body varies upon a temperature change even with the light emitting device driven at the same current or voltage. In an organic EL device, for example, the light emission efficiency of the luminous body increases with a temperature rise. Conversely, the light emission efficiency of a light emitting diode, for example, decreases with a temperature rise.

Taking into account such a tendency, in this second exemplary embodiment, a variation in the light emission efficiency generated among the light emitting devices 1 due to the temperature distribution is reduced by setting the resistance values of the resistors 2 to be different from each other. More specifically, resistance values R_{2MIN}, R_{2LOW}, R_{2HIGH}, and R_{2MAX} of the resistors are set to different values depending on respective brightness-temperature characteristics of the light emitting devices 1 so that the brightnesses of the light emitting devices 1 are held constant.

The principle for giving a distribution to the resistance values of the resistors from the above point of view is described in a quantitative way. The distribution of the resistance values (i.e., the resistance distribution) at the same temperature is determined depending on a temperature-brightness characteristic: L=g₁(T′), a brightness-current characteristic: L=f₁(I), and a current-voltage characteristic: I=h₁(V₁) of the luminous body (or the light emitting device 1). Here, L is the brightness of the luminous body, T′ is the temperature of the luminous body, and g₁(T′) represents a function of T′. Also, I is the current flowing through the light emitting device 1, and f₁(I) represents a function of the current I. V₁ is the voltage applied to the light emitting device 1, and h₁(V₁) represents a function of V₁. In addition to the temperature characteristic of the luminous body, the temperatures of other components of the light emitting device 1 can also be taken into consideration as required.

Because the resistor 2 is connected in series to the light emitting device 1, the current I flows through the resistor 2 when the voltage V is applied to both the light emitting device 1 and the resistor 2 through the wirings 3. When the resistor 2 has a resistance value R′, a voltage V₂ applied to the resistor 2 is expressed by V₂=R′I.

Accordingly, a voltage V₁ applied to the light emitting device 1 is expressed by V₁=V−R′I. This formula can be rewritten into I=h₁(V₁)=h₁(V−R′I). Thus, I=h₂(V, R′) is obtained for the current I as a function of V and R′. By substituting the function I=h₂(V, R′) in L=f₁(I), L=f₂(V, R′) is obtained for the brightness L as a function of V and R′.

Therefore, the relationship between T′ and R′, i.e., R′=g₂(T′) can be determined from g(T′)=f₂(R′)=Lc so that the brightness L takes a constant value Lc when the driving voltage V is set to a constant value Vc.

That relationship can be determined, as described above, depending on the temperature-brightness characteristic, the brightness-current characteristic, and the current-voltage characteristic of the light emitting device 1. In other words, if the characteristics of the light emitting device 1 are experimentally confirmed even when those characteristics are not theoretically determined, a proper distribution can be given to the resistance values of the resistors during the driving based on those characteristics.

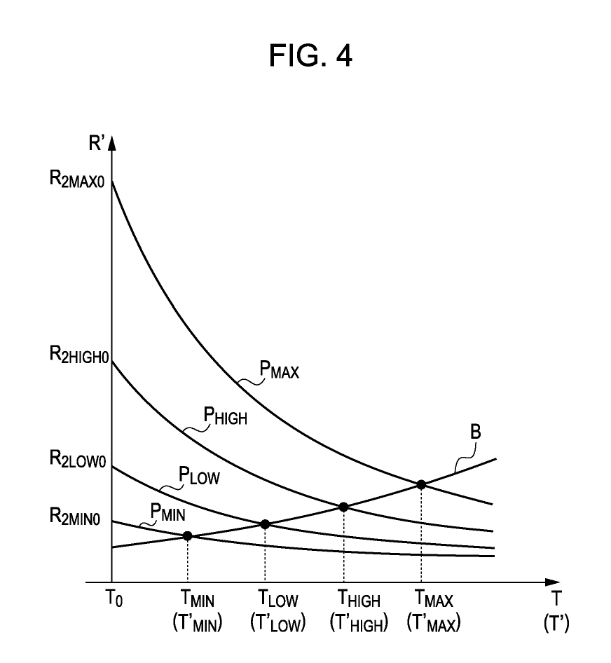

A method of setting the distribution in the resistance values of the resistors 2 according to the second exemplary embodiment of the present invention will be described below with reference to FIGS. 2 and 4. In FIG. 4, parameters for the horizontal axis are set such that an upper parameter indicates the temperature T of each resistor 2, and a lower parameter put in a parenthesis indicates the temperature of the light emitting device 1 connected to the corresponding resistor 2. Further, in FIG. 4, a vertical axis indicates the resistance value of each resistor 2, and four solid lines represent resistance-temperature characteristics of the resistors 2 at P_{MIN}, P_{LOW}, P_{HIGH}, and P_{MAX}, respectively.

This second exemplary embodiment can be advantageously applied to the case where the temperature T′ of the light emitting device 1 is substantially equal to the temperature T of the resistor 2. The temperature of the light emitting device 1 and the temperature of the resistor 2 are substantially the same, for example, when the light emitting device 1 and the resistor 2 are arranged at close positions, and/or when the light emitting device 1 and the resistor 2 are interconnected through a material having good thermal conductivity. This second exemplary embodiment can also be advantageously applied to the case where the temperature distribution among the light emitting devices 1 and the temperature distribution among the resistors 2 show a similar tendency.

While the following description is made about the case where the temperature distribution among the light emitting devices 1 and the temperature distribution among the resistors 2 show a similar tendency, it is equally applied to the case where the temperature T′ of the light emitting device 1 and the temperature T of the resistor 2 are substantially the same. Also, in the case described below, the light emitting device 1 has such a brightness-temperature characteristic that the brightness increases as the temperature rises.

It is assumed that, when a temperature distribution of T_{MIN}<T_{LOW}<T_{HIGH}<T_{MAX} occurs among the resistors 2 as in the first exemplary embodiment, a similar temperature distribution of T′_{MIN}<T′_{LOW<T′}_{HIGH}<T′_{MAX} also occurs among the light emitting devices 1. Here, respective temperatures of the light emitting devices 1 at the four points P_{MIN}, P_{LOW}, P_{HIGH}, and P_{MAX} are T′_{MIN}, T′_{LOW}, T′_{HIGH}, and T′_{MAX}.

Respective resistance values R′ of the resistors 2 connected to the light emitting devices 1 during the driving, when the light emitting devices 1 take respectively the temperatures T′=T′_{MIN}, T′_{LOW}, T′_{HIGH} and T′_{MAX} during the driving, are set based on the above-described formula R′=g₂(T′), i.e., the relationship obtained from the brightness-temperature characteristic.

A line B illustrated in FIG. 4 is obtained, based on the line A which is illustrated in FIG. 3 and represents the certain value R_{EQ} taken by the resistance values of the resistors 2 in the state providing the reference temperature distribution in the first exemplary embodiment, by changing the resistance values of the resistors 2 during the driving so as to satisfy the relation formula R′=g₂(T′) of the temperature and the resistance value for the light emitting device 1 and the resistor 2.

In the brightness-current characteristic of a self-light emitting device, the brightness L usually increases as the current I increases. Therefore, the brightness can be reduced by reducing the current, and hence by increasing the resistance value of the resistor 2 connected to the light emitting device 1.

When the brightness-temperature characteristic of the light emitting device 1 is such that the brightness increases as the temperature rises, an increase of the brightness can be suppressed by setting the resistance value of the resistor 2 during the driving, which is connected to the light emitting device 1 having a higher temperature, to a larger resistance value.

Thus, because of the relationship that the resistance value of the resistor is set to be larger as the temperature of the light emitting device 1 increases, the resistance values of the resistors during the driving are set so as to satisfy the relationship of R_{2MIN}<R_{2LOW}<R_{2HIGH}<R_{2MAX}.

On the other hand, as described above, R′ is also related to the temperature T of the resistor 2 as expressed by the formula (1). Accordingly, respective resistance values R₀′=R_{2MIN0}, R_{2LOW0}, R_{2HIGH0} and R_{2MAX0} of the resistors at the same temperature T₀ can be each determined from the following formula (10):

g₂(T′)=R₀′exp{(Eₐ/k_{b})×(1/T−1/T₀)} (10)

Because the resistor 2 has the negative resistance-temperature characteristic, the resistance values R₀′ of the resistors 2 at the same temperature T₀ are set in the relationship of R_{2MIN0}<R_{2LOW0}<R_{2HIGH0}<R_{2MAX0}. In other words for the light emitting device 1 having a higher temperature during the driving and the resistor 2 connected to the relevant light emitting device 1, the resistance value is required to be set to a larger value at the same temperature. Hence, in the self-light emitting device, the line B in FIG. 4 shows a similar tendency to that of the brightness-temperature characteristic of the light emitting device when the vertical axis in FIG. 4 is assumed to indicate the brightness.

Thus, this second exemplary embodiment can be advantageously applied to the case where the brightness-temperature characteristic of the light emitting device 1 is such that the brightness increases as the temperature rises.

On the other hand, when the brightness-temperature characteristic of the light emitting device 1 is such that the brightness decreases as the temperature rises, a reduction of the brightness can be suppressed for the light emitting device 1 having a higher temperature and the resistor 2 connected to the relevant light emitting device 1 by setting the resistance value during the driving to a smaller value. This second exemplary embodiment can be satisfactorily applied unless, in the range between T_{MIN} and T_{MAX} in FIG. 4, the line B comes below a line P_{MIN} that represents the resistance-temperature characteristic of the resistor taking T_{MIN}.

While the above description is made about the case where the temperature distribution among the light emitting devices 1 exhibits a similar tendency to that of the temperature distribution among the resistors 2, nonuniformity in the brightness can be likewise reduced by setting the resistance value during the driving so as to satisfy the formula of R′=g₂(T′) even when the temperature distribution among the light emitting devices 1 does not exhibit a similar tendency to that of the temperature distribution among the resistors 2. In particular, this second exemplary embodiment can be advantageously applied to the case where an extent of the temperature distribution among the light emitting devices 1 is smaller than that of the temperature distribution among the resistors 2.

According to the second exemplary embodiment, as described above, nonuniformity in the brightness can be more satisfactorily reduced when temperature distribution occurs among both the light emitting devices 1 and the resistors 2. As in the first exemplary embodiment, the most satisfactory result is obtained when the light emitting apparatus is driven under similar conditions to those providing the reference temperature distribution.

A method of making the resistance values different from each other at the same temperature in the first and second exemplary embodiments will be described below, for example, in connection with the light emitting apparatus according to the exemplary embodiment of the present invention in which a cathode luminescence device is used as the light emitting device 1.

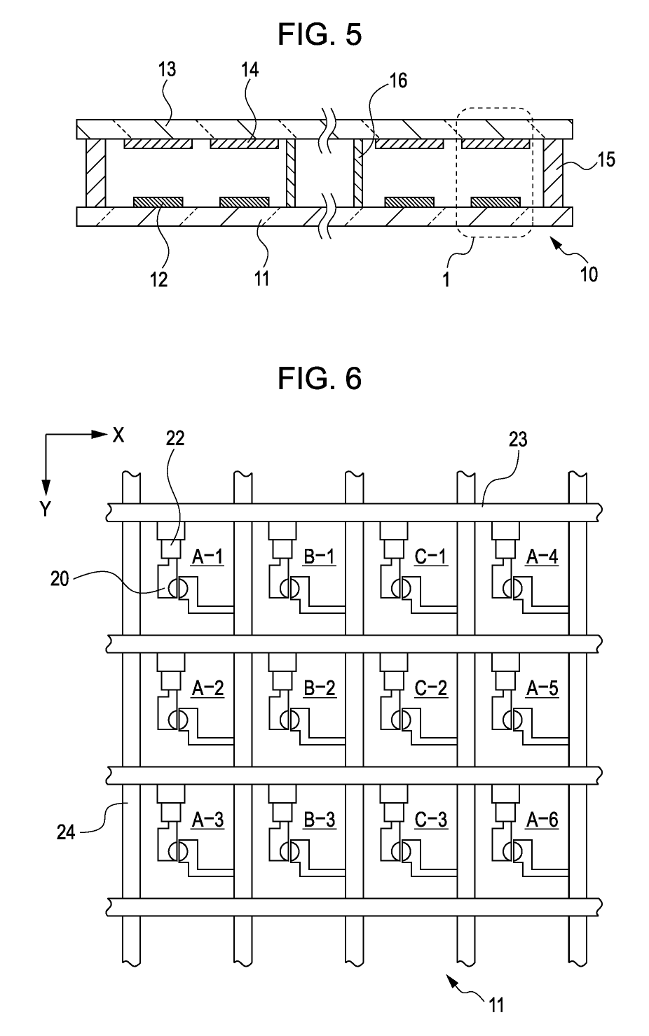

FIG. 5 illustrates the basic structure of the light emitting apparatus using the cathode luminescence device. A rear plate 11 includes a plurality of electron emitting devices 12. Examples of the electron emitting devices 12 include the field emission type, surface conduction type, the MIM type, and the MIS type. A face plate 13 includes a plurality of phosphors 14. The rear plate 11 and the face plate 13 are arranged such that the electron emitting devices 12 and the phosphors 14 face each other in pair. A frame 15 constitutes an enclosure for keeping a space between both the plates 11 and 12 in a vacuum state. A spacer 16 (e.g., a member in the form of a plate, a column, a rib or the like) serves not only to hold the distance between both the plates 11 and 12, but also to constitute a structure endurable against the atmospheric pressure. The rear plate 11 includes, in addition to the electron emitting devices, electrodes and wirings (not shown) for driving the electron emitting devices. Electrons emitted from the electron emitting devices 12 are irradiated to the phosphors 14 with a positive potential applied to the face plate 13, whereby the phosphors 14 are excited to emit light. Thus, one pair of the electron emitting device 12 and the phosphor 14 constitutes one light emitting device 1.

The following description is made in connection with the electron emitting device of the surface conduction type. A typical structure, a manufacturing method, and characteristics of the electron emitting device of the surface conduction type are disclosed in, e.g., Japanese Patent Laid-Open No. 2-56822. Also, typical structures, manufacturing methods, and characteristics of the electron emitting device of the layered type are disclosed in, e.g., Japanese Patent Laid-Open No. 2001-167693 and No. 2001-229809.

FIG. 6 illustrates the positional relationship between a plurality of electron emitting devices disposed on the rear plate 11 and the resistors connected to the electron emitting devices. In FIG. 6, the electron emitting devices of the surface conduction type are employed as the electron emitting devices 12 on the rear plate 11 in FIG. 5. Referring to FIG. 6, reference numeral 20 denotes an electron emitting device of the surface conduction type, 22 denotes a resistor, 23 denotes a first wiring extending in the X-direction, and 24 denotes a second wiring extending in the Y-direction. The plurality of electron emitting devices 20 are formed so as to have the same characteristics, but their characteristics may often vary in fact. Wirings include the first wiring 23 and the second wiring 24. By applying different potentials to the first wiring 23 and the second wiring 24, a voltage corresponding to the difference between the applied potentials is supplied to the electron emitting device 20. Namely, the so-called simple matrix wiring is constituted. The first wiring 23 is a scanning wiring to transfer a scanning signal that selects an X row to be driven, and the second wiring 24 is an information wiring to transfer an information signal that is applied to the electron emitting device.

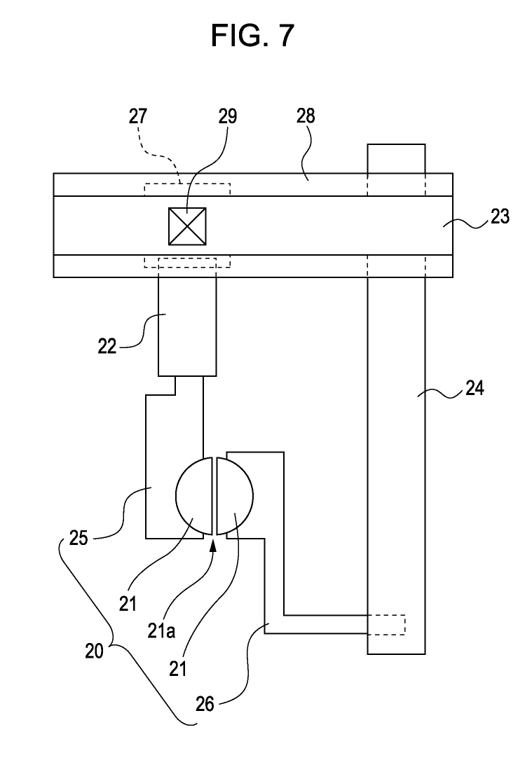

FIG. 7 illustrates the detailed structure of one electron emitting device 20, the wirings for driving the electron emitting device 20, etc. The electron emitting device 20 includes an electron emitting film 21, a scanning-signal device electrode 25, and an information-signal device electrode 26. The electron emitting film 21 has an electron emitting portion 21a in the form of a slit, and electrons are emitted by generating a high electric field in the slit.

One end of the resistor 22 is connected in series to the electron emitting device 20. The scanning-signal device electrode 25 and the information-signal device electrode 26 are each a connecting member having a low resistance and are formed in such shapes as facilitating respectively the connection between the one end of the resistor 22 and the electron emitting device 20 and the connection between the electron emitting device 20 and the second wiring 24. The other end of the resistor 22 is connected in series to the first wiring 23 through an extended electrode 27. The extended electrode 27 is also a connecting member having a low resistance and is formed in such a shape as facilitating the connection between the resistor 22 and the first wiring 23.

An insulating film 28 secures insulation in an area where the first wiring 23 and the second wiring 24 cross each other. The insulating film 28 is also disposed partly between the extended electrode 27 and the first wiring 23. The extended electrode 27 connected to the electron emitting device 20 through the resistor 22 is connected to the first wiring 23 via a contact hole 29 formed in the insulating film 28.

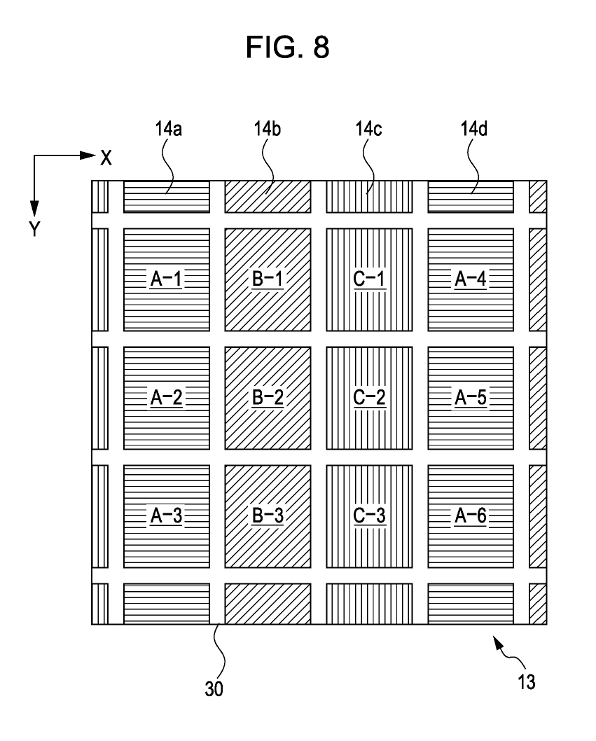

FIG. 8 illustrates the structure of the face plate 13 including a plurality of phosphors. In FIG. 8, a black matrix 30 serves to divide the face plate 13 into unit areas and has a plurality of openings through which light is emitted to the outside. The phosphors include phosphors 14a, 14b and 14c emitting lights in different colors from each other. Typically, the phosphors 14a, 14b and 14c emit respective lights in red, green or blue. Light emitting areas are formed by arranging the phosphors 14a, 14b and 14c plural per color on the face plate 13 in a matrix pattern. Addresses (A-1 to A-6, B-1 to B-3, and C-1 to C-3) assigned to the phosphors 14a, 14b and 14c correspond to addresses (A-1 to A-6, B-1 to B-3, and C-1 to C-3) assigned to the electron emitting devices 20 in FIG. 6.

While the electron emitting devices 20 on the rear plate 11 are substantially the same, the phosphors on the face plate 13 emit lights in different colors. Therefore, when the electron emitting devices 20 and the phosphors are arranged to face each other to form the light emitting devices, the light emitting devices to be compared with each other for compensation are ones corresponding to the phosphors emitting lights in the same color. Using the addresses assigned as illustrated in FIGS. 6 and 7, the plurality of light emitting devices to be taken into consideration in the exemplary embodiments of the present invention are ones having the addresses A-1, A-2, . . . , A-6. In particular, the temperature difference tends to increase when the light emitting devices are positioned away from each other such as ones having the addresses A-1 and A-6.

In the light emitting apparatus having the above-described structure, one electron emitting device 20, one phosphor 14, and one resistor 22 constitute one light emitting unit 5. The light emitting apparatus is constituted by arraying a plurality of light emitting units 5 (having the addresses A-1, A-2, . . . , A-6, etc.).

The light emitting apparatus using the above-described electron emitting devices may often have a variation in electron emission characteristics. When the simple matrix wiring is employed as described above, there is a possibility that, if one electron emitting device is short-circuited for some reason, a large current flows in such an excessive amount as damaging the electron emitting device and the voltage can no longer be applied to the other electron emitting devices.

To overcome the above-mentioned problem, the resistor 22 connected to each electron emitting device 20 is required to have a high resistance. In other words, a variation in the emission current-applied voltage characteristic of the electron emitting device 20 can be reduced by connecting a resistor having a high resistance in series to the electron emitting device 20 and restricting the current flowing into the electron emitting device 20 with the provision of the resistor. Further, the resistor having the high resistance can suppress a large current from flowing to the wirings even if the electron emitting device 20 is short-circuited, and can prevent damage of the other electron emitting devices. For those reasons, the resistance value of the resistor is desirably in the range of not less than 1 kΩ and not more than 10 GΩ. For example, when an emission current of 100 μA flows, a resistance value of 10 kΩ generates a voltage drop of 1 V.

Moreover, since the electron emitting device is basically manufactured through a photolithographic process, the resistor is formed as a thin film. To obtain the above-mentioned resistance value in that case, a material of the resistor desirably has the volume resistivity of not less than 10⁻³ Ωm or 1 kΩ/(unit square) with a thickness of 1 μm.

Such a high-resistance material can be selected from among various materials including, e.g., Si, a-Si, Si—C, TaN, amorphous carbon, DLC, cermet, silicide, an oxide semiconductor, a nitride semiconductor, ATO (Antimony-containing Tin Oxide), SnO₂, WGeON, PtAlN, AlN, and ZnO. Many of those materials have semiconductor characteristics and exhibit the negative resistance-temperature characteristic. For example, the activation energy Eₐ is about 0.05 eV for AuSiON, about 0.1 eV for PtAlN, about 0.14 eV for TaN, about 0.3 eV for WGeON, and about 0.8 eV for a-Si. The thin film resistor can be formed by suitable one of methods including vacuum film-forming processes, e.g., vacuum vapor deposition, sputtering, and plasma CVD, as well as spin coating, spraying, etc.

As described above, the light emitting apparatus using the electron emitting devices has the structure suitable for practicing the first exemplary embodiment of the present invention.

The second exemplary embodiment of the present invention can also be suitably applied to the light emitting apparatus using the electron emitting devices. More specifically, as described above, the rear plate 11 including the electron emitting devices 12 and the face plate 13 including the phosphors 14 are arranged to face each other, and a space between both the plates 11 and 13 is held in the vacuum state. This provides a structure in which heat generated from heat sources, such as the electron emitting devices 12 and the wirings, are hard to conduct to the phosphors 14. Therefore, an extent of temperature distribution generated among the phosphors 14 on the face plate 13 on the side closer to the display surface is smaller than that of temperature distribution on the rear plate 11 including the resistors 2. Hence, the second exemplary embodiment can also be suitably applied to the light emitting apparatus using the electron emitting devices.

When the second exemplary embodiment is applied to the light emitting apparatus using the electron emitting devices, the brightness-current characteristic of the light emitting device can be expressed by L=f₁(I)=κ(η×I)^{γ}. Herein, κ is light emission efficiency of the phosphor, η is efficiency of the electron emitting device, and γ is a gamma characteristic of the phosphor. The current-voltage characteristic of the electron emitting device is expressed by the Flower-Nordheim's formula I=h₁(V₁)=aV₁²exp(−b/V₁). Herein, a and b are coefficients. Accordingly, when the resistor 2 having a resistance value R′ is employed, I=a(V−R′I)²exp{−b/(V−R′I)} is obtained. The brightness-temperature characteristic L=g(T′) can be provided as a temperature characteristic of the phosphor light-emission efficiency κ that is quantitatively determined depending on the type of the phosphor.

A method of practically giving a distribution to the resistance values of the resistors will be described below. As seen from the formula (1), the resistance values at the reference temperature T₀ can be made different from each other by a method of changing the shapes of the resistors and a method of changing materials of the resistors such that the volume resistivity and/or the activation energy Eₐ are set to different values. From the viewpoint of compensating for the temperature distribution with higher accuracy in the exemplary embodiment of the present invention, it is desirable to prepare many variations for setting of the resistance values. In the case of forming thin-film resistors, however, the manufacturing process becomes very complicated if different materials are used for forming the plurality of resistors. For that reason, the resistors are formed by using the same material, and the resistance values of the resistors are made different from each other by changing any of the length, the width and the thickness of the resistor, or a combination of those parameters.

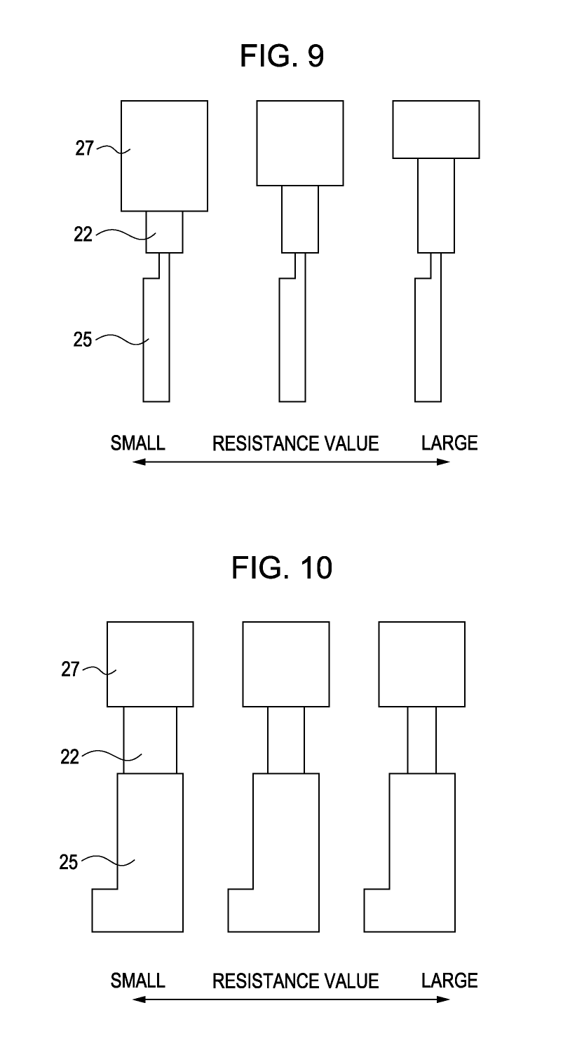

FIG. 9 illustrates an exemplary manner of giving a distribution to the resistance values of the resistors 22 by changing the length of the resistor 22. For the sake of explanation, FIG. 9 illustrates only the scanning-signal device electrode 25, the resistor 22, and the extended wiring 27, which are illustrated in FIG. 7. The resistance value is increased by gradually increasing the length of the resistor 22. For example, when the resistance value of some resistor is to be increased 1.5 times, the length of the relevant resistor 22 is increased 1.5 times. While the length of the resistor 22 is changed on the side closer to the extended wiring 27 in FIG. 9, the length of the resistor 22 may be changed on the side closer to the scanning-signal device electrode 25.

Alternatively, the effective length of the resistor 22 may be changed by changing the lengths of portions of the extended wiring 27 and the scanning-signal device electrode 25, which are overlapped with the resistor 22, while the length of the resistor 22 itself is held constant. Although the resistor 22 in FIG. 9 has a rectangular shape, the effective length of the resistor 22 may be changed by changing the shape of the resistor 22 to a zigzag form.

FIG. 10 illustrates an exemplary manner of giving a distribution to the resistance values of the resistors 22 by changing the width of the resistor 22. The resistance value is increased by gradually narrowing the width of the resistor 22. For example, when the resistance value of some resistor is to be increased 1.5 times, the width of the resistor 22 at the center is set to be 1/1.5 time the width of the resistor 22 at the edge (end).

Although the resistor 22 has a rectangular shape in FIG. 10, the effective width of the resistor 22 may be changed by forming a cutout in the resistor 22 so as to partly change the resistor width.

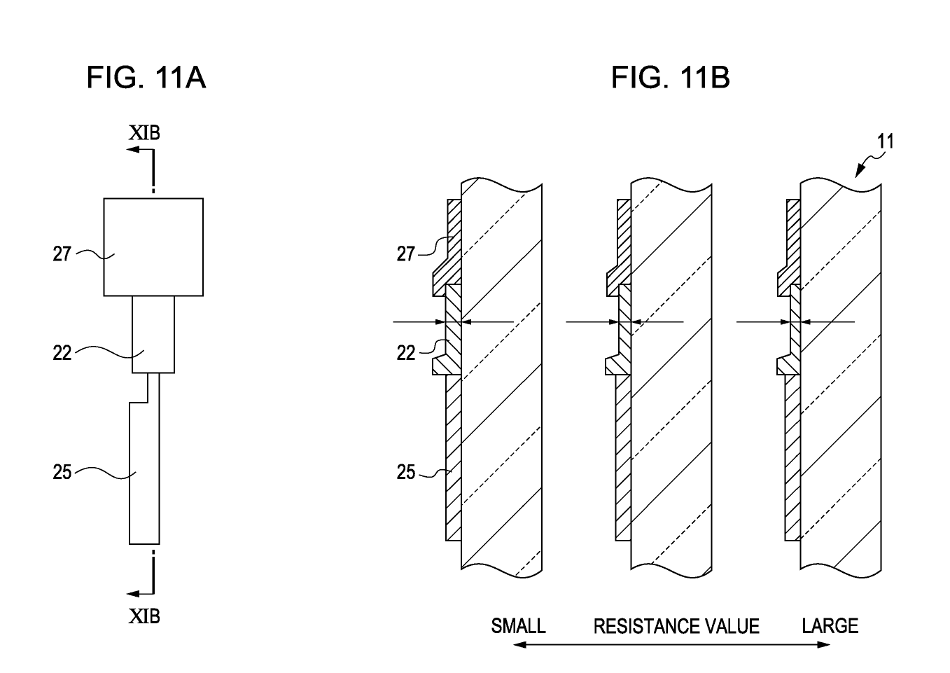

FIGS. 11A and 11B illustrate an exemplary manner of giving a distribution to the resistance values of the resistors 22 by changing the thickness of the resistor 22. FIG. 11A is a plan view, and FIG. 11B is a sectional view taken along a line XIB-XIB in FIG. 11A. The resistance value is increased by gradually reducing the thickness of the resistor 22. For example, when the resistance value of some resistor is to be increased 1.5 times, the thickness of the relevant resistor 22 is set to be 1/1.5 time.

While the direction in which the current flows is the direction of length of the resistor 22 (i.e., the direction parallel to a substrate) in the above description, the direction of the current may be the direction of thickness of the resistor 22 (i.e., the direction vertical to the substrate). As still another example, a distribution may be given to the resistance values of the resistors by changing a contact area between the resistor and the wiring.

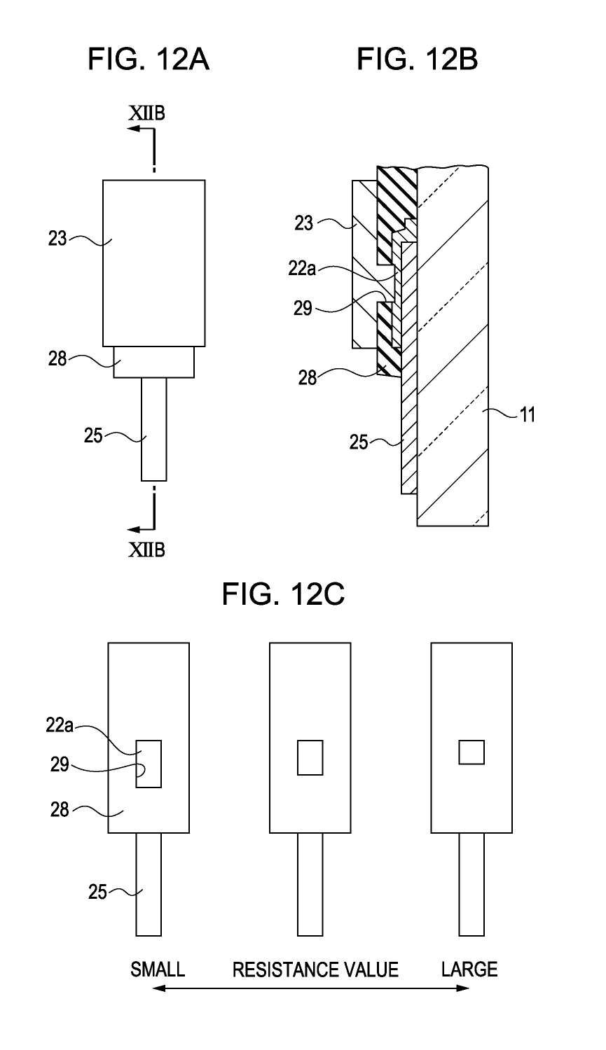

FIG. 12A is a plan view of a portion covering the signal line and the device electrode, and FIG. 12B is a sectional view taken along a line XIIB-XIIB′ in FIG. 12A. In FIG. 12B, a resistor 22a, an insulating layer 28, and a scanning signal wiring 23 are successively stacked on the scanning-signal device electrode 25 in the order named. The insulating layer 28 has an opening 29 formed therein such that the scanning signal wiring 23 and one end of the scanning-signal device electrode 25 are electrically connected to each other through the resistor 22a.

The other end of the scanning-signal device electrode 25 is connected to the electron emitting device 20 (not shown in FIGS. 12A and 12B). FIG. 12C illustrates an exemplary manner of giving a distribution to the resistance values of the resistors. For the sake of explanation, the scanning signal wiring 23 on the insulating layer 28 is not illustrated in FIG. 12C. The resistance value between the scanning signal wiring 23 and the scanning-signal device electrode 25 can be changed by varying the area of the opening 29 as illustrated in FIG. 12C. For example, when the resistance value of some resistor is to be increased 1.5 times, the area of the opening 29 is set to be 1/1.5 time.

Thus, by changing the contact area between the resistor 22a and the wiring 23, a distribution is given to the resistance values of the resistors. As an alternative, the resistance distribution may be given by changing the thickness of the resistor 22a.

While the present invention will be described below in more detail in connection with Examples, it is to be noted that the present invention is not limited to the following Examples.

### Example 1

A method of fabricating the components of the image display apparatus, illustrated in FIG. 5, will be described below.

### (Fabrication of Rear Plate)

First, a method of fabricating the rear plate 11 used in Example 1 is described. A typical array of the electron emitting devices 12 in the light emitting apparatus of FIG. 5 is the simple matrix array, illustrated in FIG. 1B, in which the X-direction wiring and the Y-direction wiring are connected to a pair of device electrodes of each electron emitting device 12.

FIG. 6 is a plan view of part of the rear plate 11. A number (N×M) of electron emitting devices 20 are formed on the rear plate 11. The number (N×M) of electron emitting devices 20 are arrayed in the simple matrix wiring by using a number M of X-direction wirings 23 and a number N of Y-direction wirings 24.

In Example 1, the electron emitting device 20 having the structure illustrated in FIG. 7 is used as the electron emitting device 12 disposed on the rear plate 11 illustrated in FIG. 5. A method of fabricating the electron emitting device 20 on the rear plate 11 and the surrounding wirings is now described. While the following description is made about one device, a plurality of electron emitting device 20 and the surrounding wirings can be formed at the same time by using the X-direction wirings 23 and the Y-direction wirings 24 in common.

### (Preparation of Substrate)

A glass commercialized under the trademark of PD-200 (made by Asahi Glass Company, Ltd.) and having a thickness of 2.8 mm is used as a substrate, and a SiO₂ film having a thickness of 200 nm is formed on the glass substrate by coating.

### (Formation of Device Electrodes)

A Ti film having a thickness of 5 nm and a Pt film having a thickness of 200 nm are formed on the glass substrate. Then, the Ti/Pt films are patterned by the photolithography to form the scanning-signal device electrode 25 and the information-signal device electrode 26. Each of those device electrode 25 and 26 has volume resistivity of 0.25×10⁻⁶ (Ωm). Further, the scanning-signal device electrode 25 is trimmed in a later-described step such that an electrode portion connected to the electron emitting film 21 has a width of 20 μm and an electrode portion connected to the resistor 22 has a width of 10 μm.

### (Formation of Resistor)

After forming a TaN film, the resistor 22 is patterned into a predetermined shape. The resistor 22 has a thickness of about 1 μm and a width of 20 μm. Lengths of individual resistors 22 are changed so as to give a distribution depending on respective positions within the display region. A manner of giving the length distribution will be described later.

### (Formation of Information Signal Wiring and Extended Wiring)

The information signal wiring 24 and the extended wiring 27 are formed by a screen printing process using a silver paste. The information signal wiring 24 has a thickness of about 10 μm and a width of 20 μm.

### (Formation of Insulating Layer)

Under the scanning line wiring 23 formed in a later step, the insulating layer 28 having a thickness of 30 μm and a width of 200 μm is formed by a screen printing process using an insulating paste. The opening 29 is formed in the insulating layer 28 in a portion of its region overlapped with the extended wiring 27.

### (Formation of Scanning Signal Wiring)

On the insulating layer 28, the scanning signal wiring 23 having a thickness of 10 μm and a width of 150 μm is formed by a screen printing process using a silver paste. In the same step, a lead wiring and a lead terminal for connection to an external driving circuit are also formed in a similar manner (though not illustrated).

### (Formation of Electron Emitting Film and Electron Emitting Portion)

An organic palladium-containing solution is applied to between the device electrodes 25 and 26 by an ink jet applicator while the applied solution is adjusted to have a dot diameter of 50 μm. Then, a palladium oxide (PdO) film having a maximum thickness of 10 μm is obtained by carrying out a high-temperature baking process in air.

An energization process is carried out on the palladium oxide film under an atmosphere containing hydrogen gas. As a result, the palladium oxide is reduced to form the electron emitting film 21 made of palladium, and a crack is partly formed in the electron emitting film 21 at the same time.

Thereafter, an energization process (activation process) is carried out on the electron emitting film 21 in an atmosphere under 1.3×10⁻⁴ Pa, thus depositing a carbon film on the electron emitting film 21. As a result, the electron emitting device 20 including the electron emitting portion 21a is obtained.

### (Fabrication of Face Plate)

A method of fabricating the face plate 13 will be described below with reference to FIG. 8. In FIG. 8, reference numeral 30 denotes a black matrix, and 14a, 14b and 14c denote phosphors in difference colors.

A glass (PD-200) is used as a substrate of the face plate 13, and the phosphors 14a, 14b and 14c are formed on the underside of the substrate. In this Example 1, to display a color image, P22 phosphors in three primary colors of red, green and blue, which are generally used in the field of CRT, are used as the phosphors 14a, 14b and 14c. The black matrix 30 is arranged so as to separate the phosphors 14a, 14b and 14c in the X-direction, and to separate individual pixels in the Y-direction. The black matrix 30 is effective in not only absorbing electrons, but also absorbing extraneous light to suppress reflection of the extraneous light at the display surface. A black pigment paste and a phosphor paste are used respectively as the black matrix 30 and the phosphors 14a, 14b and 14c. The black matrix 30 and the phosphors 14a, 14b and 14c are formed on the face plate 13 by screen-printing the respective pastes and baking them.

Thereafter, a metal back (not shown) serving as a reflective layer is formed by smoothing the surfaces of the phosphors 14a, 14b and 14c and vapor-depositing Al thereon in vacuum with a thickness of 100 nm. The face plate 13 is thus fabricated.

### (Formation of Display Panel)

Finally, the frame 15 is arranged, as illustrated in FIG. 5, at peripheral edges of the rear plate 11 and the face plate 13, and a space defined by both the plates 11 and 13 and the frame 15 is sealed off in vacuum while the distance between both the plates 11 and 13 is maintained at 2 mm by the spacers 16. Through the above-described steps, a matrix display panel having pixels in number of 3072×768 and pixel pitches of 200×600 μm is obtained.

In the image display apparatus constructed as described above, voltages are applied to the electron emitting devices through the respective wirings. Further, an image is displayed by applying a voltage to the metal back of the face plate 13 through a high-voltage terminal. At that time, 0 or 10 V is applied to the information signal wiring 24, 0 or −20 V is applied to the scanning signal wiring 23, and 15 KV is applied to the metal back. An electric circuit as a driving unit is installed at a position slightly deviated rightward from the center as viewed from the backside of the rear plate 11.

A method of setting the resistance values of the resistors 22 will be described below. In this Example 1, the resistance value of the resistor 22 is set to be larger at the same temperature T₀ in a region taking a higher temperature in the temperature distribution that occurs when an image is displayed by the image display apparatus.

Further, the resistor 22 in this Example 1 is made of TaN and has activation energy of 0.14 eV and volume resistivity of 0.01 Ωm. Additionally, the same temperature T₀ is set to 300K, and the constant resistance value R_{EQ} during the operation is set to 10 kΩ.

Conditions for measuring the temperature distribution during the driving will be described below. The temperature distribution in the display region is measured when all the pixels of the image display apparatus are lit up at the environmental temperature of 300K with a gradation of 100% and a temperature change is saturated. Also, the temperature distribution is measured by attaching 25 thermocouples in a matrix pattern to the backside (i.e., the surface not including the electron emitting devices) of the rear plate 11. The temperature change has become small after the lapse of 60 minutes. Although the temperature is measured from the backside of the rear plate 11, the thermocouple shows substantially the same value as the temperature of the corresponding resistor 22. The result of the temperature measurement in the light emitting apparatus of this Example 1 provides a temperature distribution that is asymmetric and exhibits a higher temperature at a position slightly deviated rightwards from the center as viewed from the backside.

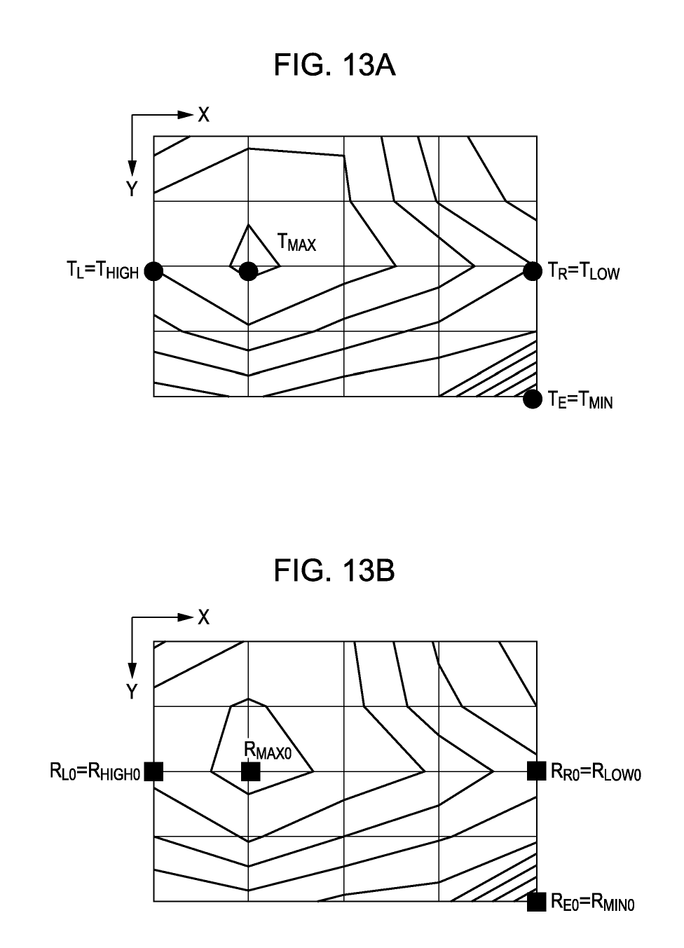

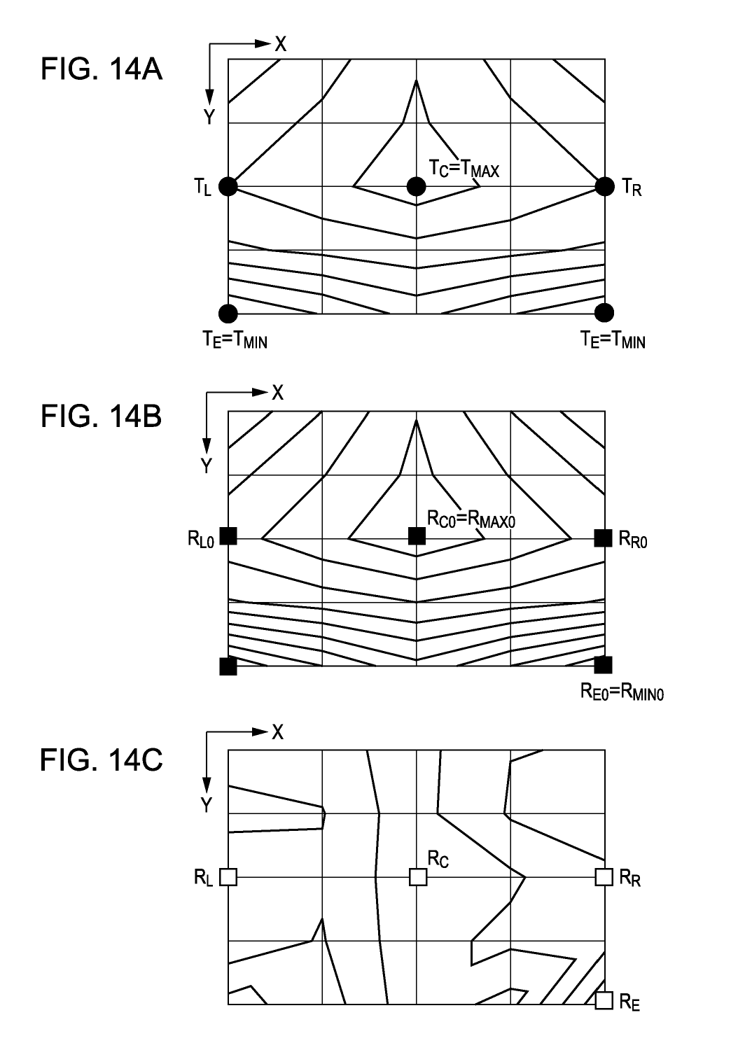

FIG. 13A illustrates a reference temperature distribution set based on the above-described measurement result. The temperature distribution illustrated in FIG. 13A represents a temperature distribution among the resistors as viewed from the side to face the display surface, i.e., the side to confront the face plate 13 (this is similarly applied to FIGS. 14 and 15 corresponding to later-described Examples). In the reference temperature distribution, the temperature (K) measured at each point is rounded to the nearest whole number, and a contour line is divided per 1K.

In the reference temperature distribution, an average temperature is 317K, a maximum temperature is T=320K at a point slightly deviated leftwards from the center in FIG. 13A, and a minimum temperature is T_{E}=T_{MIN}=310K at a point corresponding to the lower right corner. Thus, the temperature difference between the maximum and minimum temperatures is about 10K. A temperature T_{L} substantially at a middle point in the left edge line is T_{L} =T_{HIGH}=319K, and a temperature T_{R} substantially at a middle point in the right edge line is T_{R}=T_{LOW}=317K lower than the temperature T_{L} substantially at the middle point in the left edge line. In FIG. 13A, the above-mentioned points are denoted by black circles.

On the basis of the reference temperature distribution illustrated in FIG. 13A, resistance values are set by using the above-described formulae (2′), (3′), (5′), (6′) and (8). FIG. 13B illustrates a resistance distribution in the display region surface at the same temperature (T₀=300K). The resistance values are indicated near black squares in FIG. 13B, which represent the same points as those indicated by the black circles in FIG. 13A.

The resistance values at room temperature (300 K) are set at the above-mentioned points such that a resistance at the point slightly deviated leftwards from the center has a maximum resistance value R_{MAX0}=14.1 kΩ, and a resistance R_{E0} at the lower right point has a minimum resistance value R_{E0} =R_{MIN0}=11.9 kΩ. The resistance values at opposite edges are set such that a resistance value R_{L0} substantially at the middle point in the left edge line is R_{L0}=R_{HIGH0}=13.8 kΩ, and a resistance value R_{R0} substantially at the middle point in the right edge line is R_{R0}=R_{LOW0}=13.4 kΩ. Thus, a distribution is given to the resistance values such that the difference between the maximum value and the minimum value is 17% with respect to the middle between the maximum value and the minimum value.

In this Example 1, the distribution is given to the resistance values by changing the pattern width of the resistor 22 as illustrated in FIG. 10. The resistor width is set to 14.2 μm at the point slightly deviated leftwards from the center, which corresponds to T_{MAX}, and to 16.8 μm at the lower right point, which corresponds to T_{MIN}. For the other points, the resistor width is similarly set depending on the temperature during the operation.

With that setting, the resistance values when the light emitting apparatus is driven under the same conditions as those used in measuring the reference temperature distribution become approximately 10.0 kΩ that is set as the constant resistance value R_{EQ}. Further, as a result of displaying images under the above-described driving conditions while the display pattern is changed in several ways, an image having small nonuniformity in its displayed view is obtained for any of the display patterns. More specifically, some nonuniformity in the displayed image is observed immediately after startup of the image display apparatus, but the nonuniformity reduces to an unappreciable level in several minutes.

### Example 2

Example 2 of the present invention will be described below. The basic structure and the manufacturing steps in Example 2 are the same as those in Example 1 and hence a description thereof is omitted. In this Example 2, the resistance values of the resistors 22 are set such that, in both longitudinal direction and the transverse direction of the image display apparatus, the resistance values of the resistors in a central portion are larger than those of the resistors in an edge portion. Therefore, this Example 2 can be suitably applied to the case of (temperature in the edge portion)<(temperature in the central portion).

As in Example 1, the resistor 22 in this Example 2 is made of TaN and has activation energy of 0.14 eV and volume resistivity of 0.01 Ωm. Similarly, the constant temperature T₀ is set to 300K, and the constant resistance value R_{EQ} during the operation is set to 10 kΩ.

A temperature distribution is measured in a similar manner to that in Example 1.

In this Example 2, the reference temperature distribution is set based on the temperatures measured in Example 1 such that the resistance value at the same temperature reduces as the distance from the center increases. As illustrated in FIG. 14A, the reference temperature distribution in this Example 2 is bilaterally symmetric. In FIG. 14A, a temperature T_{C} at a point in the central portion is set to a maximum temperature T_{MAX}=320K, and a temperature T_{K} at a point corresponding to each of the lower left and right corners is set to a minimum temperature T_{MIN}=313K that is an average value of the temperatures at the lower right and left points. Temperatures T_{L} and T_{R} substantially at middle points in the left and right edge lines are set to T_{L}=T_{R}=318K that is an average value of the temperatures at the right and left edges. The above-mentioned points are denoted by black circles in FIG. 14A. A temperature between the central portion and the right and left edges is determined by interpolation.

On the basis of the reference temperature distribution illustrated in FIG. 14A, resistance values in the central portion and the edge portions are set by using the above-described formulae (2′), (3′), (5′), (6′) and (8). FIG. 14B illustrates a resistance distribution in the display region surface at the constant temperature (T₀=300K). The resistance values are indicated near black squares in FIG. 14B, which represent the same points as those indicated by the black circles in FIG. 14A. In FIG. 14B, a resistance value R_{c0} in the central portion is set to a maximum resistance value R_{MAX0}=13.9 kΩ, and a resistance value R_{E0} at each of the lower left and right edges is set to a minimum resistance value R_{MIN0}=12.5 kΩ. Resistance values R_{L0} and R_{R0} substantially at the middle points in the left and right edge lines are each set to R_{L0}=R_{R0}=13.6 kΩ. Thus, a distribution is given to the resistance values such that, at 300K, the difference between the maximum value and the minimum value is 11% with respect to the middle between the maximum value and the minimum value.

In this Example 2, the distribution is given to the resistance values by changing the pattern length of the resistor 22 as illustrated in FIG. 9. The length of the resistor is set to gradually increase from the left and right edges toward the central portion such that the resistor length is 27.8 μm in the central portion and 27.2 μm substantially at each of the middle points in the left and right edge lines.

FIG. 14C illustrates a resistance distribution when a temperature distribution differing from the temperature distribution illustrated in FIG. 13A, i.e., from the reference temperature distribution, is generated. Voided squares in FIG. 14C represent points corresponding to the black circles in FIG. 14A and the black squares in FIG. 14B. R_{C} and R_{R} are each 10.2 kΩ, and R_{L} is 9.9 kΩ. A maximum resistance value in the display region surface is 10.5 kΩ and a minimum resistance value therein is 9.6 kΩ. Thus, the difference between the maximum resistance value and the minimum resistance value is 9% with respect to the middle between both the values, and the resistance values become approximately 10.0 kΩ that is the set resistance value. In other words, the resistance distribution in the display region surface can be suppressed as illustrated in FIG. 14C.

Further, as a result of displaying images under similar driving conditions to those in Example 1 while the display pattern is changed in several ways, an image having small nonuniformity in its displayed view is obtained for any of the display patterns.

### Example 3

Example 3 of the present invention will be described below. This Example 3 employs a structure in which, as illustrated in FIG. 12, the scanning signal wiring 23 and the scanning-signal device electrode 25 are connected to each other through the resistor 22a such that a current flows in the direction of thickness of the resistor 22a. The other structure and the manufacturing steps in Example 3 are the same as those in Example 1 and hence a description thereof is omitted. In this Example 3, a distribution is given to the resistance values by changing the contact area between the resistor 22a and the scanning signal wiring 23.

Part of the manufacturing steps, which is the same as that in Example 1, is not described here.

First, the scanning-signal device electrode 25 and the information-signal device electrode 26 are formed on a glass substrate. Then, an a-Si film is formed thereon by sputtering and is patterned to form the resistor 22a on the scanning-signal device electrode 25. The resistor 22a has a thickness of about 60 nm and a width of 20 μm. The resistor 22a in this Example 3 is made of a-Si and has activation energy of 0.8 eV and volume resistivity of 100 Ωm.

Then, the information signal wiring 24 is formed and the insulating layer 28 is further formed. The opening 29 is formed in the insulating layer 28 in a portion of its region overlapped with the resistor 22a on the scanning-signal device electrode 25. The opening 29 has a width of 15 μm and a length varied so as to provide a distribution among the opening lengths. A manner of providing the length distribution will be described later.

Then, the scanning signal wiring 23 is formed on the insulating layer 28. Finally, the electron emitting film 21 and the electron emitting portion 21a are formed.

A method of setting the resistance distribution will be described below. In this Example 3, as in Example 1, the resistance value of the resistor 22a is set to be larger at the same temperature T₀ in a region taking a higher temperature in the temperature distribution that occurs when an image is displayed by the image display apparatus. The reference temperature distribution (FIG. 15A) is set to the same as that, illustrated in FIG. 13A, set in Example 1. Further, as in other Examples, the constant resistance value R_{EQ} during the operation is set to 10 kΩ. On the basis of the reference temperature distribution illustrated in FIG. 15A, resistance values are set by using the above-described formulae (2′), (3′), (5′), (6′) and (8).

FIG. 15B illustrates a resistance distribution in the display region surface at the same temperature (T₀=300K). The resistance values are indicated near black squares in FIG. 15B, which represent the same points as those indicated by the black circles in FIG. 15A. In FIG. 15B, a maximum resistance value is R_{MAX0}=66 kΩ at a point slightly deviated leftwards from the center, and a minimum resistance value is R_{MIN0}=27 kΩ at a point corresponding to the lower right corner. Further, in FIG. 15B, resistance values at points (denoted by black squares) at the opposite edges under the same temperature T₀is R_{L0}=63 kΩ on the left side and R_{R0}=53 kΩ on the right side. The difference between the maximum value and the minimum value is 84% with respect to the middle between the maximum value and the minimum value.

In this Example 3, the distribution is given to the resistance values by changing the area of the opening 29. More specifically, the area of the opening 29 is changed by changing the length of the opening 29 as illustrated in FIG. 12C. The opening length is 6.1 μm at the point corresponding to the maximum resistance value and is 14.8 μm at the point corresponding to the minimum resistance value. At each of the other points, the length of the opening 29 is similarly set depending on the temperature at that point.

At room temperature (300K), as in Example 1, the resistance values become approximately the constant resistance value 10.0 kΩ at all the points when the temperature distribution illustrated in FIG. 15A generates.

Further, as a result of displaying images under similar driving conditions to those in Example 1 while the display pattern is changed in several ways, an image having small nonuniformity in its displayed view is obtained for any of the display patterns.

### Example 4

Example 4 of the present invention will be described below. Example 4 mainly differs from Example 1 in the structure of the electron emitting device 12 on the rear plate 11 of the light emitting panel illustrated in FIG. 5, and in having a plurality of electron emitting devices to constitute one light emitting device. In this Example 4, resistors are connected in series to the plurality of electron emitting devices, respectively. In other words, a plurality of resistors are connected in series to one light emitting device.

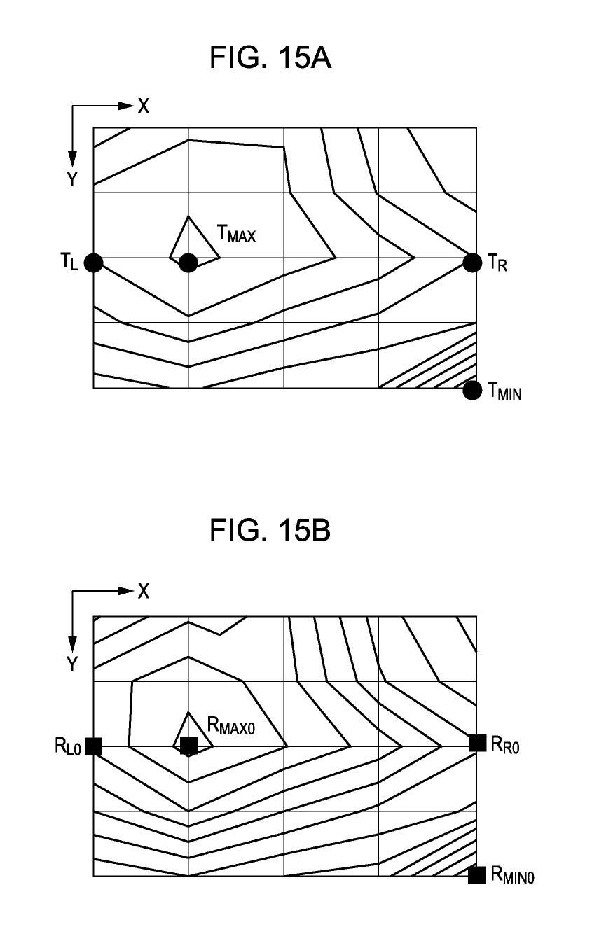

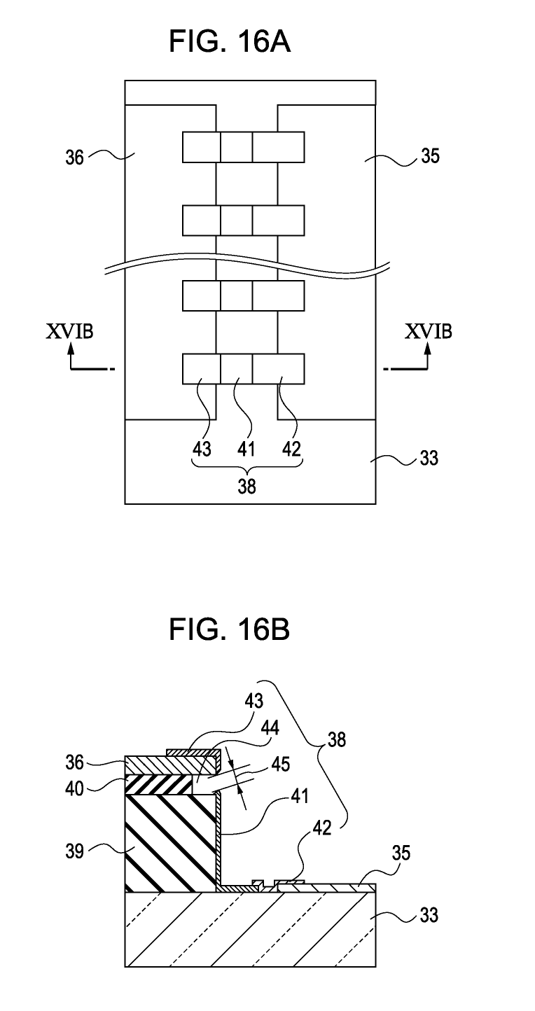

FIGS. 16A and 16B are schematic views illustrating the electron emitting device of this Example 4 in an enlarged scale. FIG. 16A is a plan view looking from above, and FIG. 16B is a sectional view taken along a line XIVB-XIVB in FIG. 16A. Referring to FIGS. 16A and 16B, reference numeral 41 denotes a multi-strip-shaped lower-potential side cathode which is electrically connected to a cathode electrode 35 through a resistor 42, and which is disposed to extend over a sidewall surface of an insulating layer 39. Reference numeral 43 denotes a multi-strip-shaped higher-potential side cathode which is electrically connected to a gate electrode 36, and 44 denote a recess which is formed in a sidewall-defining step by recessing a sidewall surface of an insulating layer 40 so as to retract from a sidewall surface of the gate electrode 36 and a sidewall surface of the insulating layer 39. Reference numeral 45 denotes a gap (minimum distance from the lower-potential side cathode 41 to the higher-potential side cathode 43) in which an electric field necessary for emitting electrons is formed.

Manufacturing steps of the rear plate 11 will be described below.

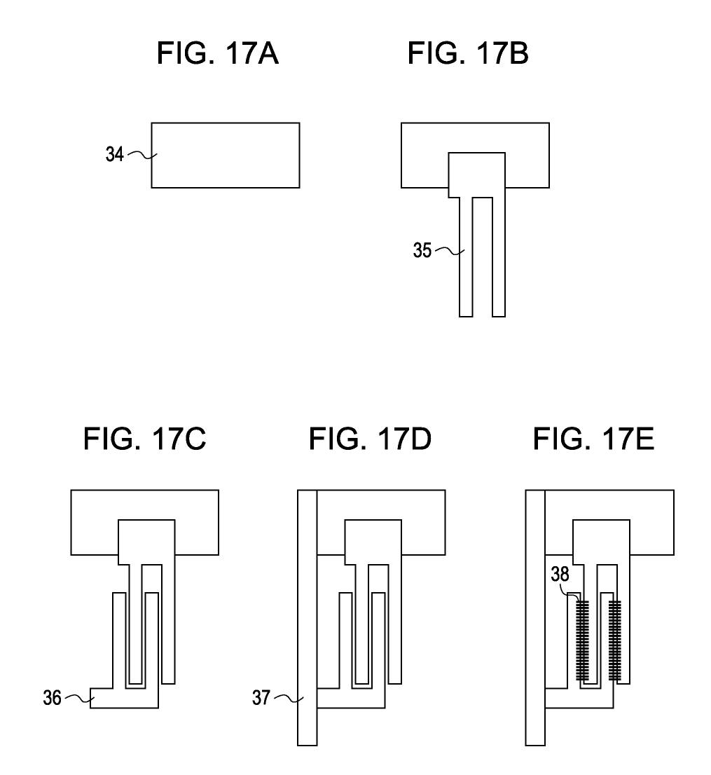

First, a Cu wiring is formed on a substrate 33 by the photolithography to form the scanning signal wiring 34 (FIG. 17A). Then, a TaN film is formed and is patterned to form the cathode electrode 35 (FIG. 17B). Though not illustrated, the insulating layer 39 and the insulating layer 40 are successively formed on the entire surface of the substrate 33 by using SiN and SiO₂, respectively. Further, a TaN film is formed and is patterned to form the gate electrode 36 (FIG. 17C). Then, a Cu film is formed and is patterned to form the information signal wiring 37 (FIG. 17D). Finally, a multi-strip-like portion 38 including the electron emitting portion and the resistor is formed (FIG. 17E).

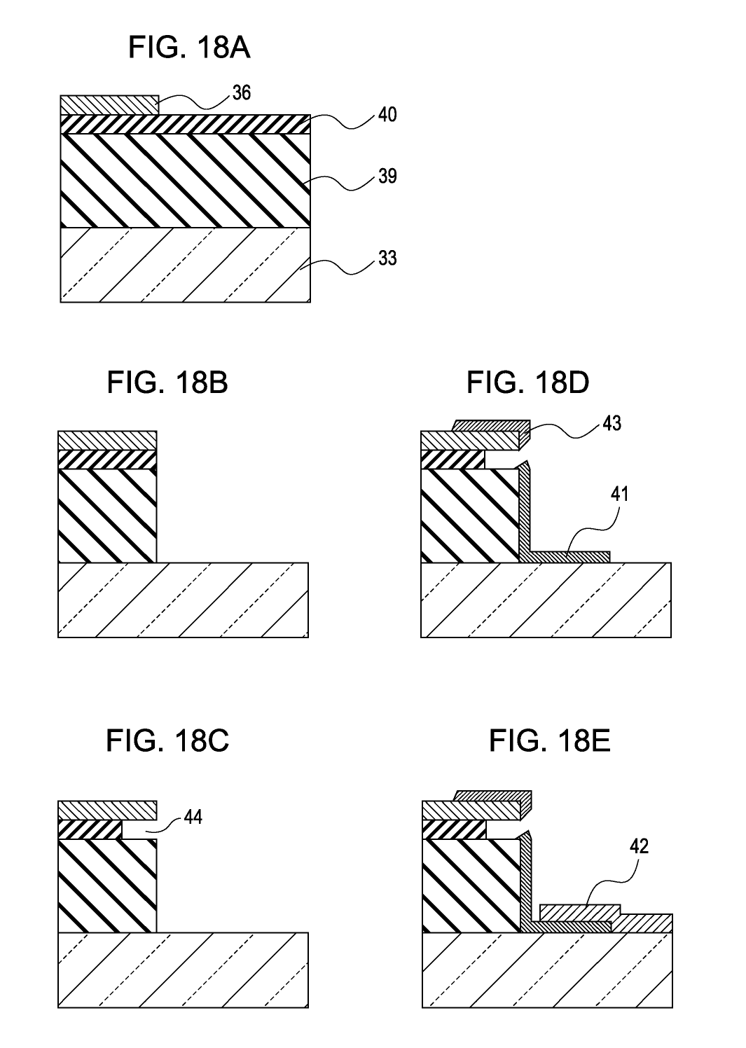

FIGS. 18A to 18E are schematic views illustrating details of the step (FIG. 17E) of forming the multi-strip-like portion 38 in this Example 4.

In the multi-strip-shaped portion 38 and thereabout, the insulating layer 39 (SiN), the insulating layer 40 (SiO₂), and the patterned gate electrode 36 (TaN) are stacked on the substrate 33 (FIG. 18A). Thicknesses of those members are respectively 500 nm, 30 nm, and 30 nm. Then, the insulating layers 39 and 40 are processed into a predetermined shape by the photolithography (FIG. 18B). Then, the insulating layer 40 is etched to form the recess 44 (FIG. 18C). Further, a molybdenum (Mo) film is formed by vapor deposition using an electron beam. After coating, exposing and developing a photoresist, the lower-potential side cathode 41 and the higher-potential side cathode 43 are processed into predetermined shapes (FIG. 18D). Finally, a WGeON film is formed by carrying out sputtering in an atmosphere, which contains nitrogen and a very small amount of oxygen, with W and Ge used as targets. Thereafter, the resistor 42 having a predetermined pattern is formed by the photolithography (FIG. 18E). The resistor 42 has a film thickness of 200 nm. Each of the lower-potential side cathode 41, the higher-potential side cathode 43, and the resistor 42 has a width of 3 μm, and the number of strips is set to 50×2 rows=100. Sectional TEM observation shows that the gap 45 has a size of about 8 nm.

Methods of manufacturing the other components including the face plate 13 and a method of forming a panel are similar to those described above, and hence a description thereof is omitted.

A method of setting the resistance distribution will be described below. In this Example 4, as in Example 1, the resistance value of the resistor 42 is set to be larger at the same temperature T₀ in a region taking a higher temperature in the temperature distribution that occurs when an image is displayed by the image display apparatus. The reference temperature distribution is set to the same as that (illustrated in FIG. 15A) set in Example 1. Further, the resistor 42 is made of WGeON and has activation energy of 0.3 eV and volume resistivity of 0.15 Ωm.

The constant resistance value R_{EQ} during the operation is set to 1.0 MΩ. This Example 4 differs from the other Examples in the arrangement of the resistor 42 and the position used to define the resistance value. In this Example 4, plural strips of the lower-potential side cathode 41 are arranged in parallel to constitute one electron emitting device. Therefore, the resistor 42 is also arranged in the form of strips corresponding to the lower-potential side cathode 41. The resistance value represents a resistance value between the multi-strip-shaped lower-potential side cathode 41 and the multi-strip-shaped cathode electrode 35.

On the basis of the reference temperature distribution illustrated in FIG. 15A, the resistance distribution in the display region surface is set by using the above-described formulae (2′), (3′), (5′), (6′) and (8). FIG. 15B illustrates a resistance distribution in the display region surface at the same temperature (T₀=300K). In FIG. 15B, a maximum resistance value at the same temperature (T₀=300K) is set to 2.1 MΩ (at the point T_{MAX} in FIG. 15A), and a minimum resistance value is set to 1.5 MΩ (at the point T_{MIN} in FIG. 15A). At each of the other points, the resistance value is set in a similar manner. A percentage of the difference between the maximum resistance value and the minimum resistance value at 300K with respect to the middle between both the values is 33%.

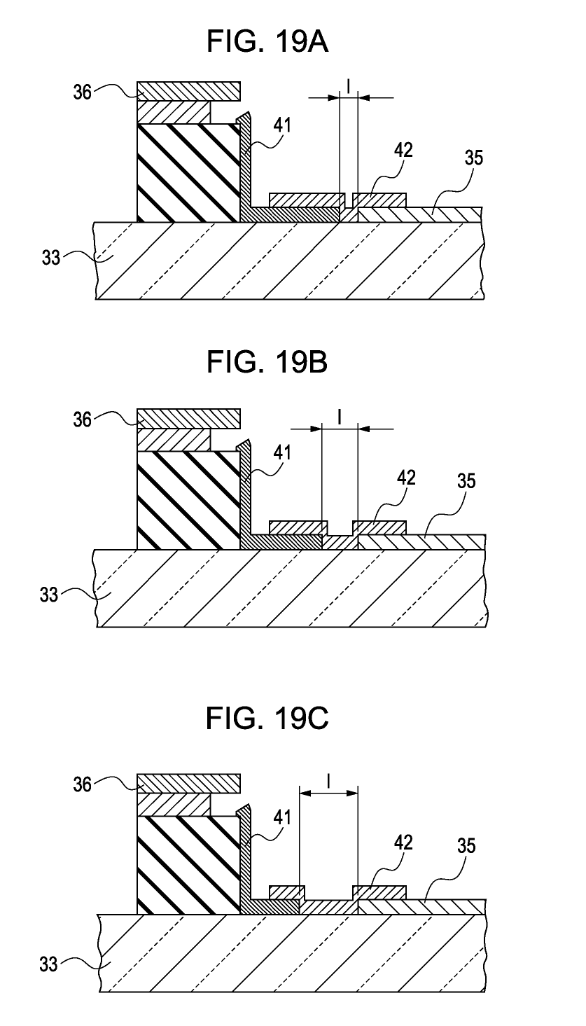

In this Example 4, the resistance value is adjusted by changing a distance l between the lower-potential side cathode 41 and the cathode electrode 35 as illustrated in FIGS. 19A, 19B and 19C. The distance l is 8.4 μm at the point corresponding to the maximum resistance value and is 6.0 μm at the point corresponding to the minimum resistance value. At each of the other points, the distance l between the lower-potential side cathode 41 and the cathode electrode 35 is similarly set depending on the temperature at that point. Thus, the resistance values become approximately 1.0 MΩ at all the points when the temperature distribution illustrated in FIG. 15A generates.

Further, as a result of displaying images under similar driving conditions to those in Example 1 while the display pattern is changed in several ways, an image having small nonuniformity in its displayed view is obtained for any of the display patterns.

### Comparative Example 1

Comparative Example 1 represents the case where the rear plate has the same structure as that in Examples 1 and 2, but a distribution is not given to the resistance values, namely, all the resistors 22 are formed in the same shape. The resistor 22 is made of TaN that has activation energy of 0.14 eV. All the resistance values are set to become R_{EQ}=10 kΩ at room temperature (300K).

An average of the resistance values of the resistors when the temperature distribution illustrated in FIG. 13A generates is 7.5 kΩ. A maximum resistance value is R_{MAX}=8.4 kΩ (at the point T_{MIN} in FIG. 13A), and a minimum resistance value is R_{MIN}=7.1 kΩ (at the point T_{MAX} in FIG. 13A). Further, the resistance values at the left and right edges (i.e., at the points T_{L} and T_{R} in FIG. 13A) are 7.2 kΩ and 7.5 kΩ, respectively. Percentages of the difference between the maximum resistance value and the minimum resistance value in the display region with respect to the average for all the resistors and with respect to the middle between the maximum resistance value and the minimum resistance value are each 17%. Thus, a distribution generates among the amounts of voltage drops caused by the resistors 22, and nonuniformity appears in an image displayed by the image display apparatus.

### Comparative Example 2

Comparative Example 2 represents the case where the structure is the same as that in Example 4, but a distribution is not given to the resistance values. The resistor 42 is made of WGeON that has activation energy of 0.3 eV. All the resistance values are set to become R_{EQ}=1.0 MΩ at room temperature (300K). An average of the resistance values of the resistors 42 when the temperature distribution illustrated in FIG. 13A generates is 0.5 MΩ. A maximum resistance value is 0.7 MΩ (at the point T_{MIN} in FIG. 13A), and a minimum resistance value is 0.5 MΩ (at the point T_{MAX} in FIG. 13A). In other words, the resistance distribution generates such that a percentage of the difference between the maximum resistance value and the minimum resistance value with respect to the average is 39% and a percentage thereof with respect to the middle between the maximum resistance value and the minimum resistance value is 33%. Thus, a distribution generates among the amounts of voltage drops caused by the resistors 42, and nonuniformity appears in an image displayed by the image display apparatus.

### Comparative Example 3

Comparative Example 3 represents the case where the structure is the same as that in Example 3 and a distribution is not given to the resistance values. The resistor 22 is made of a-Si that has activation energy of 0.8 eV. All the resistance values are set to become R_{EQ}=10 kΩ at room temperature (300K).

An average of the resistance values of the resistors when the temperature distribution illustrated in FIG. 15A generates is 1.9 kΩ. A maximum resistance value is 3.7 kΩ (at the point T_{MIN} in FIG. 15A), and a minimum resistance value is 1.4 kΩ (at the point T_{MAX} in FIG. 15A). In other words, the resistance distribution generates such that a percentage of the difference between the maximum resistance value and the minimum resistance value with respect to the average is 119% and a percentage thereof with respect to the middle between the maximum resistance value and the minimum resistance value is 90%. Thus, a distribution generates among the amounts of voltage drops caused by the resistors 22, and nonuniformity appears in an image displayed by the image display apparatus.

### (Evaluation)

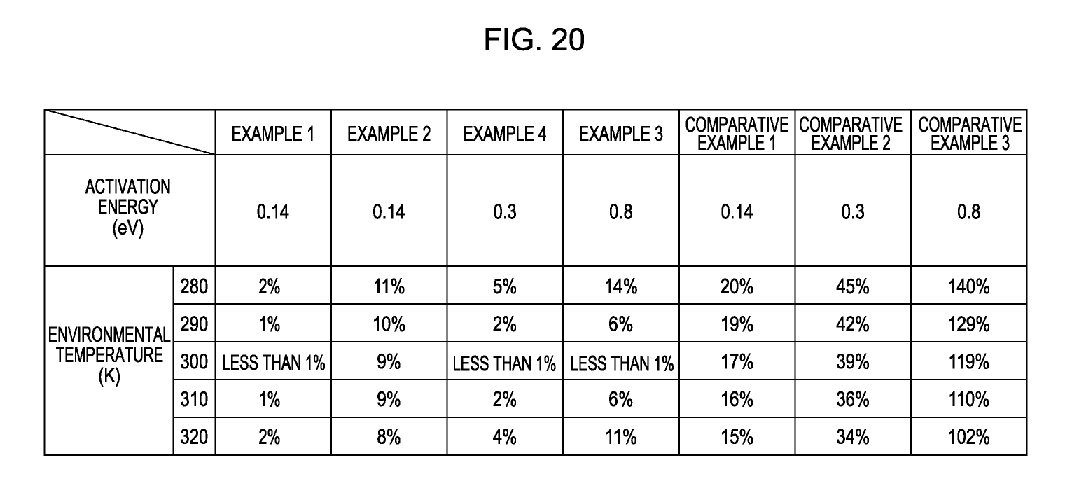

To confirm the versatility of Examples, the effect has been checked while changing the ambient temperature under which the image display apparatus is operated (i.e., the environmental temperature). FIG. 20 illustrates an extent ((maximum value−minimum value)/mean value) of nonuniformity in a displayed image, which is generated when all pixels of the image display apparatus are lit up in Examples 1 to 4 and Comparative Examples 1 to 3 while the environmental temperature during the operation is changed ±20K. In FIG. 20, Examples and Comparative Examples are listed in ascending order of activation energy from the left to the right. With the activation energy having a higher level, the extent of nonuniformity in the displayed image varies in a larger amount when the environmental temperature at which the image display apparatus is operated is changed.

In Example 1 (activation energy: 0.14 eV), a more satisfactory result, i.e., a smaller extent of nonuniformity in the displayed image, is obtained in comparison with Comparative Example 1 having the same activation energy. In Example 2, the nonuniformity in the displayed image appears in part of edge portions at relatively low temperature, but the nonuniformity in the displayed image over the entire screen is more satisfactorily reduced to a lower extent than in Example 1.

In Example 4 (activation energy: 0.3 eV), a more satisfactory result, i.e., a smaller extent of nonuniformity in the displayed image, is obtained in comparison with Comparative Example 2 having the same activation energy, and the nonuniformity in the displayed image is reduced to a half or below that in Comparative Example 1 having a lower level of the activation energy. Further, in Example 3 having a higher level of activation energy (0.8 eV), the nonuniformity in the displayed image appears at relatively low temperature (environmental temperature of 280K) and relatively high temperature (environmental temperature of 320K), but an image having a smaller extent of the nonuniformity in the displayed image is obtained in comparison with Comparative Example 3 having the same activation energy. In addition, comparing with Comparative Example 1 having a lower level of the activation energy, more satisfactory results are obtained at both relatively low and high temperatures in Example 3. In Examples 1 to 4, because the resistance values are set to become optimum at the environmental temperature of 300K, the nonuniformity in the displayed image may occur at relatively high and low temperatures. As a matter of course, however, the resistance values may also be set to become optimum at either relatively high or low temperature.

As described above, the nonuniformity in the displayed image during the operation of the image display apparatus can be reduced by previously giving a distribution to the resistance values at the same temperature.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-272126 filed Oct. 22, 2008, which is hereby incorporated by reference herein in its entirety.

What is claimed is:

1. A light emitting apparatus comprising a plurality of light emitting devices including luminous bodies, and a plurality of resistors having negative resistance-temperature characteristics, the plurality of resistors being connected respectively in series to the plurality of light emitting devices, the plurality of resistors exhibiting different temperatures from each other during driving,
wherein the plurality of resistors are made of the same material, and
when the plurality of resisters are at the same temperature, one or ones among the plurality of resistors, which exhibit higher temperatures during the driving, have larger resistance value than other one or ones among the plurality of resistors, which exhibit lower temperatures during the driving.

2. The light emitting apparatus according to claim 1, wherein one or ones among the plurality of resistors, which have a maximum resistance value at the same temperature, exhibit a maximum temperature during the driving, and other one or ones among the plurality of resistors, which have a minimum resistance value at the same temperature, exhibit a minimum temperature during the driving.

3. The light emitting apparatus according to claim 1, wherein the plurality of the light emitting devices exhibit different temperatures during the driving, and the resistance values of the resistors during the driving are made different from each other based on brightness-temperature characteristics of the light emitting devices.

4. The light emitting apparatus according to claim 3, wherein the light emitting devices have brightness-temperature characteristics providing higher brightness with an increase of temperature.

5. The light emitting apparatus according to claim 1, wherein the plurality of resistors are two-dimensionally arrayed, and ones among the plurality of resistors, which are positioned nearer to a central portion, have larger resistance values at the same temperature than other resistors, which are positioned farther away from the central portion.

6. The light emitting apparatus according to claim 1, wherein the temperatures of the plurality of resistors during the driving are defined as temperatures obtained when temperature changes in the plurality of resistors during the driving are saturated.

7. The light emitting apparatus according to claim 1, wherein the material of the resistors has activation energy of not lower than 0.1 eV and not higher than 0.6 eV.

8. The light emitting apparatus according to claim 1, further comprising simple matrix wirings connected to the plurality of resistors.

9. The light emitting apparatus according to claim 1, wherein the light emitting device comprises an electron emitting device and a phosphor which emits light upon irradiation of electrons emitted from the electron emitting device.

10. The light emitting apparatus according to claim 10, wherein the resistance value of the resistor during the driving is not less than 1 kΩ and not more than 10 GΩ.

11. The light emitting apparatus according to claim 10, wherein volume resistivity of the resistor during the driving is not less than 10⁻³ Ωm.

12. An image display apparatus comprising the light emitting apparatus according to claim 1, and a driving unit including a circuit configured to select the light emitting device from which light is to be emitted, and a circuit configured to modulate brightness at which the light is emitted.
